(19) United States
(12) Patent Application Publication
(10) Pub. No.: US 2025/0385052 A1
(43) Pub. Date: Dec. 18, 2025

(54) CAPACITOR ENERGY STORAGE SYSTEM

(71) Applicant: Pathfinder Technology LLC, Denver, CO (US)

(72) Inventor: Anoup Kaul, Edmonton (CA)

(21) Appl. No.: 19/236,404

(22) Filed: Jun. 12, 2025

Related U.S. Application Data
(60) Provisional application No. 63/659,396, filed on Jun. 13, 2024.

(51) Int. Cl. H01G 9/26; H01G 9/045; H01G 9/28; H02J 7/00; H02J 7/34

(52) U.S. Cl. CPC H01G 9/26; H01G 9/045; H01G 9/28; H02J 7/007182; H02J 7/345

(57) ABSTRACT

Various implementations include a capacitor system. The capacitor system includes an outer capacitor, an inner capacitor embedded within the outer capacitor, a power source connected to the outer capacitor, and a control circuit. The control circuit is configured to charge the outer capacitor using the power source, charge the inner capacitor across an external load using an electric field generated by the outer capacitor, and discharge the inner capacitor across the external electrical load.

### BACKGROUND

Energy storage systems play a fundamental role in modern technology, powering everything from portable electronics to electric vehicles and grid-scale applications. Traditional energy storage technologies include batteries, which store energy through electrochemical reactions, and capacitors, which store energy in electric fields between conductive plates separated by dielectric materials.

Conventional capacitors can charge and discharge rapidly but typically store relatively small amounts of energy compared to batteries. Supercapacitors, also known as ultracapacitors or electrochemical capacitors, bridge the gap between traditional capacitors and batteries by offering higher energy density than conventional capacitors while maintaining rapid charge and discharge capabilities. Supercapacitors achieve this through the use of high surface area electrodes and electrolytes, allowing for greater charge storage capacity.

The energy density of storage systems remains a limiting factor in many applications. While lithium-ion batteries offer energy densities around 300 Whr/kg, and fossil fuels like gasoline provide approximately 46 MJ/kg, there continues to be demand for storage systems that can provide higher energy densities while maintaining the cycling capabilities and rapid charge/discharge characteristics of capacitive systems.

Current capacitor technologies face trade-offs between energy density, power density, and cycle life. Supercapacitors can typically withstand millions of charge-discharge cycles, far exceeding the cycle life of most battery technologies, but their energy density remains lower than that of batteries. This limitation affects their applicability in applications where both high energy density and long cycle life are desired.

### SUMMARY

Various implementations include a capacitor system. The capacitor system includes an outer capacitor, an inner capacitor embedded within the outer capacitor, a power source connected to the outer capacitor, and a control circuit. The control circuit is configured to charge the outer capacitor using the power source, charge the inner capacitor across an external load using an electric field generated by the outer capacitor, and discharge the inner capacitor across the external electrical load.

In some implementations, the outer capacitor includes a pair of conductive plates separated by a dielectric material. In some implementations, the conductive plates of the outer capacitor are made of a material selected from the group consisting of aluminum, copper, and stainless steel.

In some implementations, the inner capacitor includes a pair of conductive plates coated with activated carbon or graphene. In some implementations, the capacitor system further includes an electrolyte membrane positioned between the conductive plates of the inner capacitor.

In some implementations, the control circuit includes a microprocessor configured to control charging and discharging cycles of the outer and inner capacitors. In some implementations, the microprocessor is programmed to maintain the voltage of the inner capacitor within a specified range.

In some implementations, the capacitor system further includes a plurality of capacitor stacks, each stack including an outer capacitor and an inner capacitor. In some implementations, the plurality of capacitor stacks are arranged in a series configuration, a parallel configuration, or a combination thereof. In some implementations, the capacitor system further includes a housing enclosing the plurality of capacitor stacks and the control circuit.

Various other implementations include a device for energy storage and delivery. The device includes a housing, a plurality of capacitor stacks within the housing, a power supply connected to the outer capacitors, and a microcontroller. Each capacitor stack includes an outer capacitor and an inner capacitor embedded within the outer capacitor. The microcontroller is configured to control charging and discharging cycles of the outer and inner capacitors.

In some implementations, the outer capacitor of each capacitor stack includes a pair of conductive plates separated by a dielectric material. In some implementations, the conductive plates of the outer capacitor are made of a material selected from the group consisting of aluminum, copper, and stainless steel.

In some implementations, the inner capacitor of each capacitor stack includes a pair of conductive plates coated with activated carbon or graphene. In some implementations, the device further includes an electrolyte membrane positioned between the conductive plates of the inner capacitor.

In some implementations, the microcontroller is programmed to maintain the voltage of each inner capacitor within a specified range. In some implementations, the microcontroller is further programmed to count a number of charging and discharging cycles and provide a warning signal when the number of cycles reaches a predetermined threshold.

In some implementations, the plurality of capacitor stacks are arranged in a series configuration, a parallel configuration, or a combination thereof. In some implementations, the device further includes a display panel integrated into the housing for providing visual information about the device's operation. In some implementations, the microcontroller is configured to control the display panel to show at least one of: voltage levels, charging status, number of completed cycles, and warning signals.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is an isometric view of a system comprising point charges within hollow spheres, according to one implementation.

FIG. 2 is a circuit diagram view of the system shown in FIG. 1 with springs and a telescoping mechanism.

FIG. 3 is a circuit diagram view of a compression spring configuration of the system shown in FIG. 1.

FIG. 4 is a circuit diagram view of an inductor and tension spring arrangement of the system shown in FIG. 1.

FIG. 5 is a circuit diagram view of a relaxed spring with motion indicators of the system shown in FIG. 1.

FIG. 6 is a circuit diagram view of a tension and compression spring configuration of the system shown in FIG. 1.

FIG. 7 is a legend view showing force and motion indicators used in the system shown in FIG. 1.

FIG. 8 is a state table view documenting operational phases of the system shown in FIG. 1.

FIGS. 9A-9D are isometric views of a charge arrangement system with central and surrounding charge pairs, according to another implementation.

FIG. 10 is a planar view of a charge array system with multiple charge pair sets, according to another implementation.

FIG. 11 is an array view of separated charge elements in parallel planar layers, according to another implementation.

FIG. 12 is a diagram view of a parallel plate capacitor configuration with electric field characteristics, according to another implementation.

FIG. 13 is a circuit diagram view of a capacitor system with outer and inner capacitor plates, according to another implementation.

FIG. 14 is a sequence diagram view showing operational states of the capacitor system shown in FIG. 13.

FIG. 15 is a plot view of voltage and current versus time for the capacitor system shown in FIG. 13.

FIG. 16 is a circuit diagram view of the capacitor system shown in FIG. 13 with additional charging components.

FIG. 17 is a graph view of outer capacitor voltage versus time for the capacitor system shown in FIG. 13.

FIG. 18 is a circuit assembly view for controlling multiple capacitor stacks, according to another implementation.

FIGS. 19A and 19B is a cross-sectional view of a single stack assembly with capacitor plates and dielectric films, according to another implementation.

FIG. 20 is an exploded view of a capacitor assembly with conductive leads, according to another implementation.

FIG. 21 is an isometric view of a single stack in an enclosure, according to another implementation.

FIG. 22 is an isometric view of a cylindrical roll assembly configuration, according to another implementation.

FIG. 23 is a schematic view of a microprocessor with input and output pins, according to another implementation.

FIG. 24 is an exploded isometric view of a mechanical assembly with enclosure and internal components, according to another implementation.

FIG. 25 is a flowchart view of a control method for the capacitor system, according to another implementation.

### DETAILED DESCRIPTION

The capacitor energy storage systems described herein comprise an outer capacitor and an inner capacitor positioned within the outer capacitor. The outer capacitor generates an electric field when charged by a power source. The inner capacitor utilizes the electric field generated by the outer capacitor for charging operations. A control circuit manages the charging and discharging cycles of both capacitors to enable energy storage and delivery through an electrical load.

The embedded configuration allows the inner capacitor to charge using the electric field created by the outer capacitor rather than through direct electrical connection to the power source. The control circuit coordinates the timing of charging and discharging operations to maintain voltage levels within specified ranges. The system operates through sequential cycles where the outer capacitor charges first, followed by charging of the inner capacitor using the established electric field, then discharge of the outer capacitor, and finally discharge of the inner capacitor through the electrical load.

In some implementations, the outer capacitor comprises conductive plates made from aluminum, copper, or stainless steel separated by dielectric materials. In some implementations, the inner capacitor comprises conductive plates coated with activated carbon or graphene with an electrolyte membrane positioned between the plates. In some implementations, multiple capacitor stacks are arranged in series or parallel configurations to meet specific voltage and current requirements. In some implementations, a microcontroller provides automated control of the charging and discharging sequences while monitoring system parameters such as voltage levels and cycle counts. In some implementations, the system includes warning mechanisms to indicate when components approach operational limits based on cycle count or performance degradation.

Various implementations include a capacitor system. The capacitor system includes an outer capacitor, an inner capacitor embedded within the outer capacitor, a power source connected to the outer capacitor, and a control circuit. The control circuit is configured to charge the outer capacitor using the power source, charge the inner capacitor across an external load using an electric field generated by the outer capacitor, and discharge the inner capacitor across the external electrical load.

Various other implementations include a device for energy storage and delivery. The device includes a housing, a plurality of capacitor stacks within the housing, a power supply connected to the outer capacitors, and a microcontroller. Each capacitor stack includes an outer capacitor and an inner capacitor embedded within the outer capacitor. The microcontroller is configured to control charging and discharging cycles of the outer and inner capacitors.

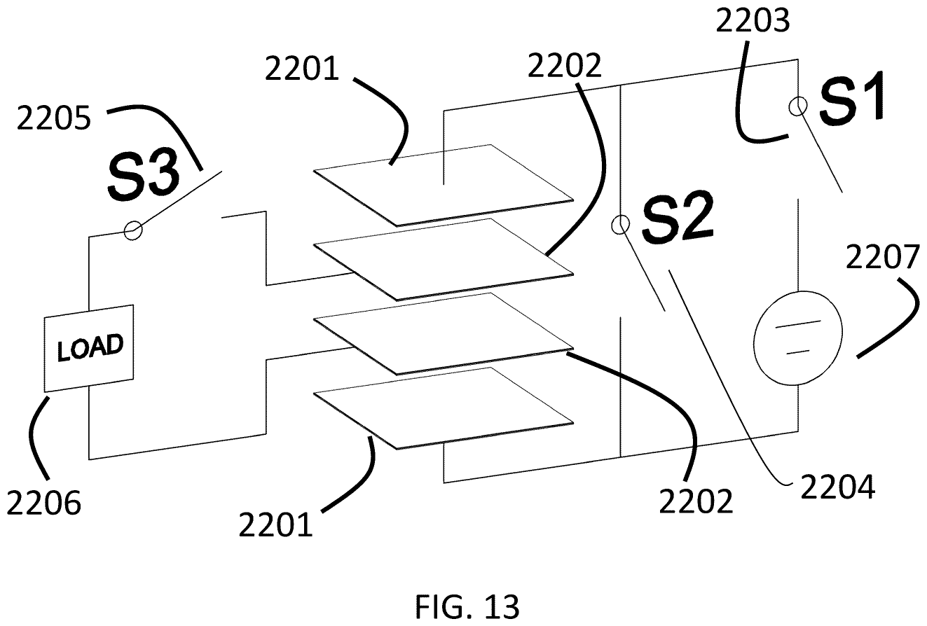

The capacitor energy storage systems described herein comprise an outer capacitor and an inner capacitor embedded within the outer capacitor, as shown in FIG. 13. The system includes a power source 2207 connected to outer capacitor plates 2201 and a control circuit with switches S1, S2, and S3 that manage charging and discharging operations. The embedded configuration enables the inner capacitor plates 2202 to charge using the electric field generated by the outer capacitor plates 2201 rather than through direct electrical connection to the power source 2207.

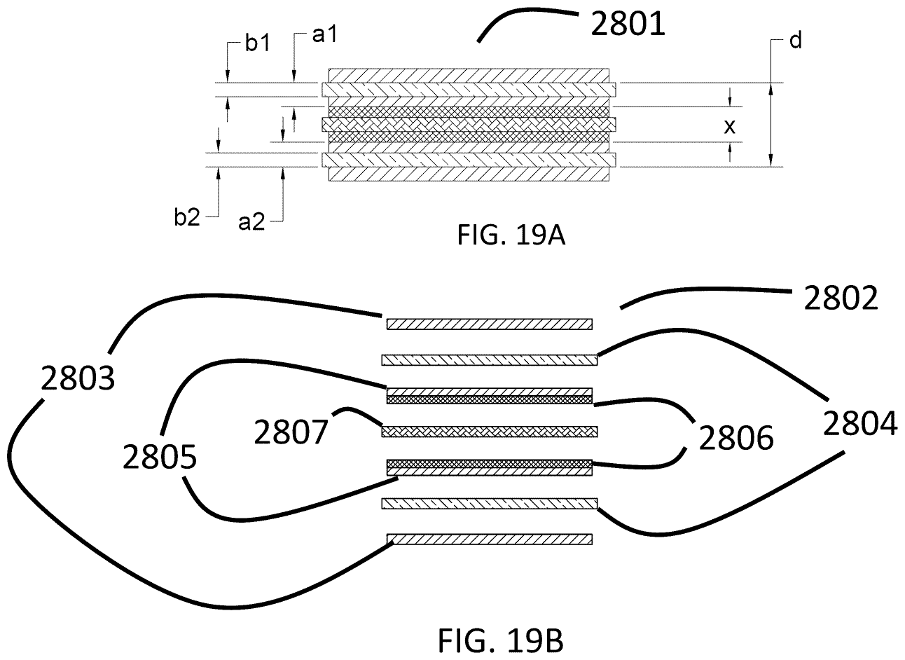

As illustrated in FIGS. 19A and 19B, the single stack assembly 2801 includes outer capacitor plates 2802 formed from conductive foils 2803 separated by dielectric films 2804. The inner capacitor plates 2805 form a capacitor sandwich 2806 with an electrolyte membrane 2807 positioned between them. The outer capacitor plates 2802 have dimensions b1 and b2 that are larger than the inner capacitor plate dimensions a1 and a2, creating the electric field environment for charging the inner capacitor. In some implementations, the conductive foils 2803 are made from aluminum, copper, or stainless steel. In some implementations, the inner capacitor plates 2805 incorporate activated carbon or graphene coatings to provide enhanced charge storage capacity. In some implementations, the outer capacitor plates made of materials such as aluminum, copper or stainless steel are sealed such that they do not chemically interact with the electrolyte. Sealing the outer capacitor plates ensures long operating life and that there is no corrosive activity or electrical conduction.

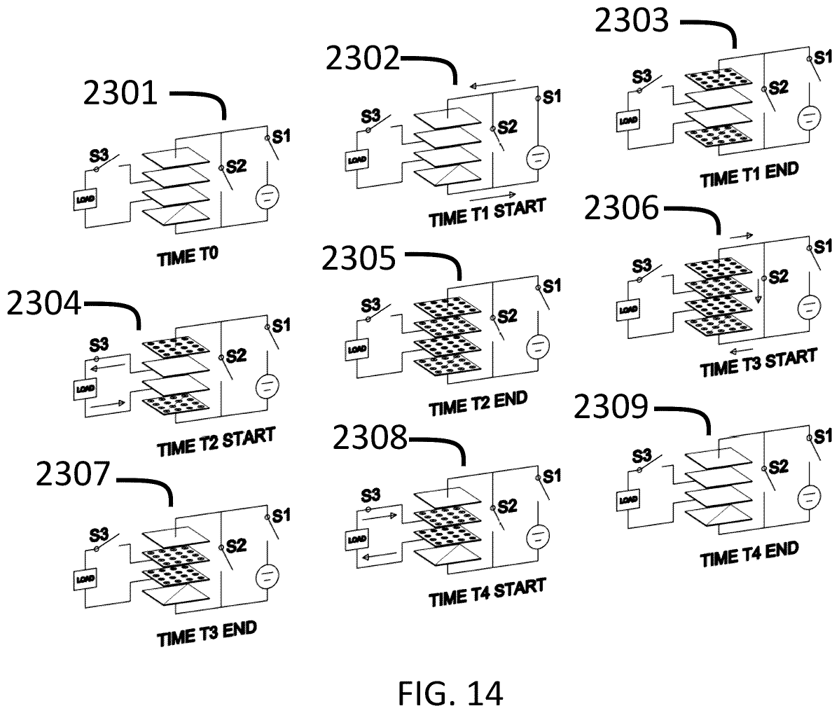

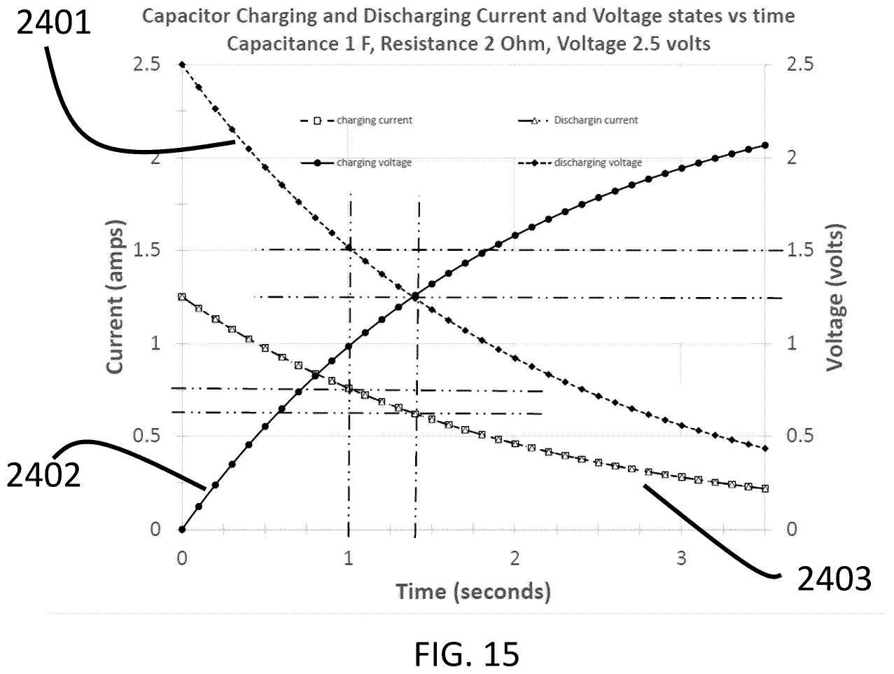

The control circuit coordinates charging and discharging cycles through sequential switch operations, as demonstrated in FIG. 14. The operational sequence progresses from initial state 2301 through outer capacitor charging 2302, inner capacitor charging 2304, outer capacitor discharging 2306, and inner capacitor discharging 2308. FIG. 15 shows the resulting voltage and current characteristics with charging voltage plot 2401, discharging voltage plot 2402, and current plot 2403. In some implementations, this sequential operation addresses trade-offs between energy density, power density, and cycle life by maintaining rapid charging capabilities while achieving enhanced energy storage levels.

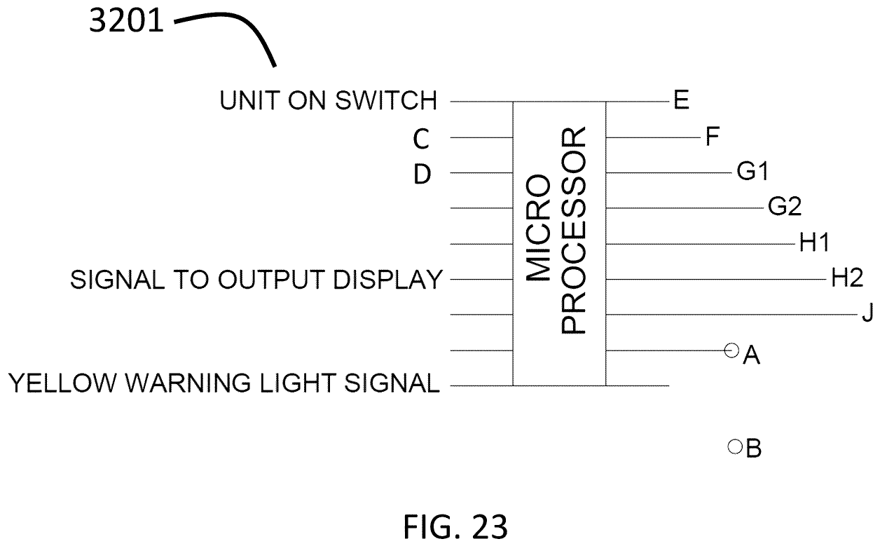

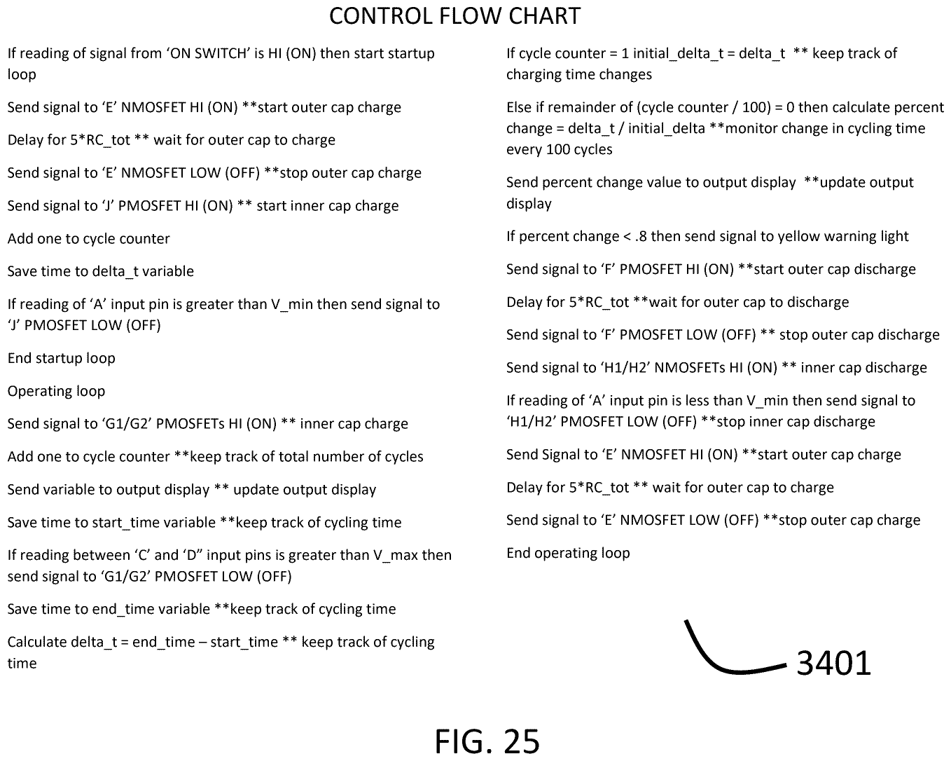

FIG. 23 shows a microprocessor 3201 with input and output pins for system control. FIG. 25 illustrates the control method 3401 that includes cycle counting, voltage monitoring, and warning signal generation. The method 3401 tracks charging and discharging cycles and activates warning indicators when performance thresholds are reached. In some implementations, this microcontroller-based monitoring provides cycle life management that extends beyond conventional capacitor systems and enables predictive maintenance throughout the system's operational life.

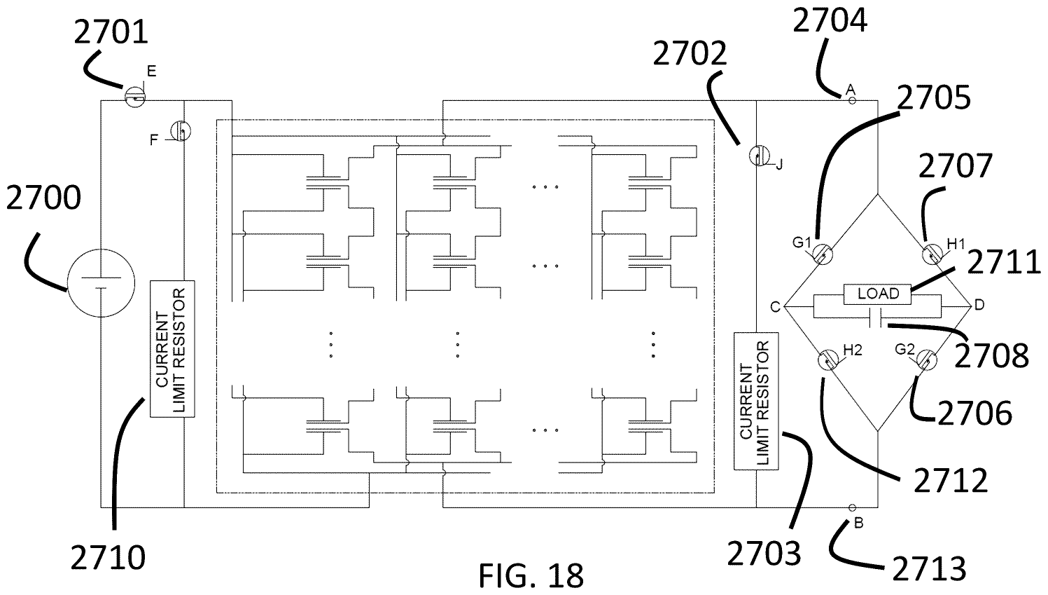

FIG. 18 depicts a circuit assembly 2700 with multiple capacitor stacks arranged in series and parallel configurations. The assembly includes control pins E 2701, J 2702, G1 2705, G2 2706, H1 2711, and H2 2712 for managing current flow through different circuit paths. A limiting resistor 2703 regulates current flow while an electrical load 2707 operates in parallel with a smoothing capacitor 2708. In some implementations, the modular stack configuration allows for scalable energy storage solutions tailored to specific voltage and current requirements while maintaining high cycle life and rapid response characteristics.

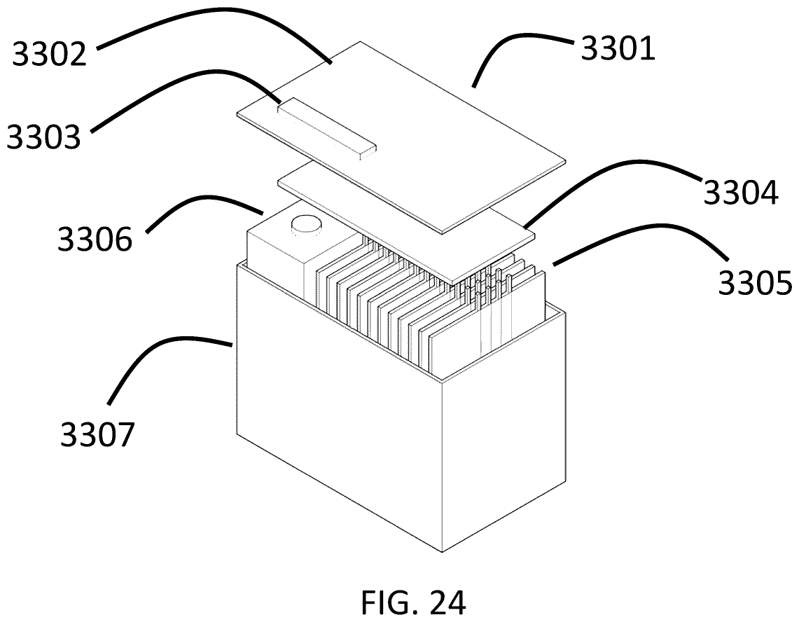

FIG. 24 shows a mechanical assembly 3301 with a display panel 3303 integrated into the enclosure lid 3302. The display panel 3303 provides visual information about system operation, including voltage levels, charging status, and cycle counts as controlled by the microprocessor. The assembly includes a control board 3304, capacitor stacks 3305, and power supply 3306 within a housing body 3307. In some implementations, this integration of display panels and user interface elements provides real-time operational feedback that enables users to optimize charging and discharging patterns based on actual system performance.

FIG. 13 shows the outer capacitor plates 2201 forming the outer capacitor component of the capacitor system. The outer capacitor plates 2201 are positioned to contain the inner capacitor plates 2202 within the electric field generated between the outer capacitor plates 2201. The power source 2207 connects to the outer capacitor plates 2201 to provide charging capability for the outer capacitor.

FIG. 19 illustrates the structural details of the outer capacitor plates 2802 within the single stack assembly 2801. The outer capacitor plates 2802 are formed from the conductive foils 2803 that provide the conductive surfaces for the outer capacitor. The conductive foils 2803 are separated by the dielectric films 2804 that provide electrical isolation between the outer capacitor plates 2802. The outer capacitor plates 2802 have a first outer width b1 and a second outer width b2 that define the dimensional characteristics of the outer capacitor structure. The first outer width b1 and the second outer width b2 are larger than the corresponding dimensions of the inner capacitor plates 2805, creating the embedded configuration where the inner capacitor plates 2805 are positioned within the electric field region established by the outer capacitor plates 2802.

In some implementations, the conductive foils 2803 are constructed from aluminum material. In some implementations, the conductive foils 2803 are made from copper material. In some implementations, the conductive foils 2803 are fabricated from stainless steel material. In some implementations, the outer capacitor plates 2802 may be oversized compared to the inner capacitor plates 2805 to create more uniform electric field effects within the capacitor system. In some implementations, the outer capacitor plates 2802 can be laminated or dip coated to create a completely sealed surface with only connection tabs exposed for electrical connections to the power source 2207.

FIG. 13 shows the inner capacitor plates 2202 positioned within the outer capacitor plates 2201 in an embedded configuration. The inner capacitor plates 2202 form the inner capacitor component that operates within the electric field environment created by the outer capacitor plates 2201. The inner capacitor plates 2202 connect to the electrical load 2206 through the control circuit switches to enable energy discharge operations.

FIG. 19 provides detailed structural information about the inner capacitor plates 2805 within the single stack assembly 2801. The inner capacitor plates 2805 form the capacitor sandwich 2806 that operates as the inner capacitor component. The inner capacitor plates 2805 have a first inner width a1 and a second inner width a2 that define the dimensional characteristics of the inner capacitor structure. The first inner width a1 and the second inner width a2 are smaller than the first outer width b1 and the second outer width b2 of the outer capacitor plates 2802, creating the embedded arrangement where the inner capacitor plates 2805 are positioned within the electric field region established by the outer capacitor plates 2802.

The inner capacitor plates 2805 comprise conductive plates coated with activated carbon. The activated carbon coating on the inner capacitor plates 2805 faces towards each other within the capacitor sandwich 2806. The electrolyte membrane 2807 is positioned between the inner capacitor plates 2805. The electrolyte membrane 2807 has a porous structure and contains suitable supercapacitor electrolyte material. The electrolyte membrane 2807 enables ionic conduction between the inner capacitor plates 2805 while maintaining electrical isolation between the conductive surfaces.

The embedded configuration positions the inner capacitor plates 2805 within the dielectric region between the outer capacitor plates 2802. The dielectric films 2804 provide electrical isolation between the outer capacitor plates 2802 and the inner capacitor plates 2805 while allowing the electric field generated by the outer capacitor plates 2802 to influence the charging behavior of the inner capacitor plates 2805. The nested capacitor arrangement enables the inner capacitor plates 2805 to charge using the electric field created by the outer capacitor plates 2802 rather than through direct electrical connection to the power source.

In some implementations, the inner capacitor plates 2805 comprise conductive plates coated with graphene instead of activated carbon. In some implementations, the graphene coating on the inner capacitor plates 2805 faces towards each other to provide enhanced charge storage capacity. In some implementations, the electrolyte membrane 2807 contains aqueous electrolyte materials that limit the voltage operation to approximately 2.5 volts. In some implementations, the electrolyte membrane 2807 contains organic non-aqueous electrolyte materials that enable voltage operation up to approximately 2.8 volts. In some implementations, the electrolyte membrane 2807 contains ionic liquid electrolyte materials that allow voltage operation up to approximately 3.0 volts.

FIG. 19 shows the dielectric films 2804 positioned between the outer capacitor plates 2802 and the inner capacitor plates 2805 within the single stack assembly 2801. The dielectric films 2804 provide electrical isolation between the conductive surfaces while maintaining proper spacing within the capacitor assembly. The dielectric films 2804 separate the outer capacitor plates 2802 from the inner capacitor plates 2805 to prevent direct electrical contact between the outer and inner capacitor components.

The dielectric films 2804 maintain a plate separation distance between the outer capacitor plates 2802 and the inner capacitor plates 2805. The plate separation distance enables the electric field generated by the outer capacitor plates 2802 to influence the inner capacitor plates 2805 while preventing electrical short circuits between the capacitor components. The dielectric films 2804 also establish a first spacing distance and a second spacing distance that define the dimensional relationships between the capacitor plates within the single stack assembly 2801.

The dielectric films 2804 are made from plastic materials including polypropylene or polyester. The polypropylene material provides electrical insulation properties that maintain isolation between the outer capacitor plates 2802 and the inner capacitor plates 2805. The polyester material offers dielectric characteristics that enable proper electric field distribution within the single stack assembly 2801 while preventing unwanted electrical conduction between the capacitor components.

In some implementations, the dielectric films 2804 may be constructed from other plastic materials that provide suitable dielectric properties for capacitor applications. In some implementations, the dielectric films 2804 may have varying thicknesses to optimize the electric field distribution between the outer capacitor plates 2802 and the inner capacitor plates 2805. In some implementations, multiple layers of dielectric films 2804 may be used to enhance the electrical isolation and mechanical stability of the single stack assembly 2801. In some implementations, the dielectric films 2804 may incorporate additives or treatments to improve their dielectric strength and temperature stability during operation.

FIG. 13 shows the power source 2207 connected to the outer capacitor plates 2201 to provide electrical energy for charging operations. The power source 2207 connects through the first control switch 2203 (S1) to enable controlled charging of the outer capacitor plates 2201. The electrical load 2206 connects to the inner capacitor plates 2202 through the third control switch 2205 (S3) to receive energy during discharge operations.

The power source 2207 provides the electrical energy input for the capacitor system. The power source 2207 supplies voltage and current to charge the outer capacitor plates 2201 when the first control switch 2203 is closed. The electrical connection between the power source 2207 and the outer capacitor plates 2201 enables energy transfer from the power source 2207 to the outer capacitor component of the system.

The electrical load 2206 receives energy output from the inner capacitor plates 2202 during discharge cycles. The electrical load 2206 connects to the inner capacitor plates 2202 through the third control switch 2205 to enable controlled energy delivery. The electrical load 2206 may consume the electrical energy provided by the inner capacitor plates 2202 to perform useful work or power external devices.

FIG. 18 depicts the circuit assembly 2700 with additional power source and load configurations. The circuit assembly 2700 includes the electrical load 2707 connected in parallel with the smoothing capacitor 2708. The smoothing capacitor 2708 operates alongside the electrical load 2707 to maintain steady voltage levels during energy delivery operations. The limiting resistor 2703 regulates current flow from the power source to prevent excessive current levels during charging operations.

The electrical load 2707 within the circuit assembly 2700 receives current flow through multiple circuit paths depending on the control pin activation states. The electrical load 2707 operates in parallel with the smoothing capacitor 2708 to maintain consistent power delivery characteristics. The smoothing capacitor 2708 stores electrical energy to reduce voltage fluctuations across the electrical load 2707 during charging and discharging transitions.

In some implementations, the power source 2207 may be a battery that provides direct current voltage for charging the outer capacitor plates 2201. In some implementations, the power source 2207 may be a rechargeable battery that can be recharged using external power sources. In some implementations, the power source 2207 may be a standard battery that provides consistent voltage output throughout the operational cycle. In some implementations, the power source 2207 may incorporate voltage regulation circuitry to maintain stable charging voltage levels.

In some implementations, the electrical load 2206 may be an electronic device that consumes electrical power from the inner capacitor plates 2202. In some implementations, the electrical load 2206 may be a resistive load that converts electrical energy to heat. In some implementations, the electrical load 2206 may be a motor or actuator that converts electrical energy to mechanical work. In some implementations, the electrical load 2206 may be connected to additional energy storage devices to capture and store the energy delivered by the inner capacitor plates 2202.

In some implementations, the smoothing capacitor 2708 may have capacitance values selected to minimize voltage ripple across the electrical load 2707. In some implementations, the limiting resistor 2703 may have resistance values chosen to limit charging current to safe operating levels for the capacitor components. In some implementations, multiple electrical loads may be connected to the circuit assembly 2700 to distribute energy output among different devices or applications.

FIG. 13 shows the control switches that manage the charging and discharging operations of the capacitor system. The first control switch 2203 operates as an outer charging switch S1 that controls the connection between the power source 2207 and the outer capacitor plates 2201. A second control switch 2204 functions as an outer discharge switch S2 that provides a discharge path for the outer capacitor plates 2201. The third control switch 2205 serves as an inner capacitor switch S3 that controls current flow between the inner capacitor plates 2202 and the electrical load 2206.

The outer charging switch S1 enables controlled charging of the outer capacitor plates 2201 when closed and prevents charging when open. The outer discharge switch S2 allows the outer capacitor plates 2201 to discharge through a shorting pathway when closed. The inner capacitor switch S3 controls the charging and discharging of the inner capacitor plates 2202 through the electrical load 2206.

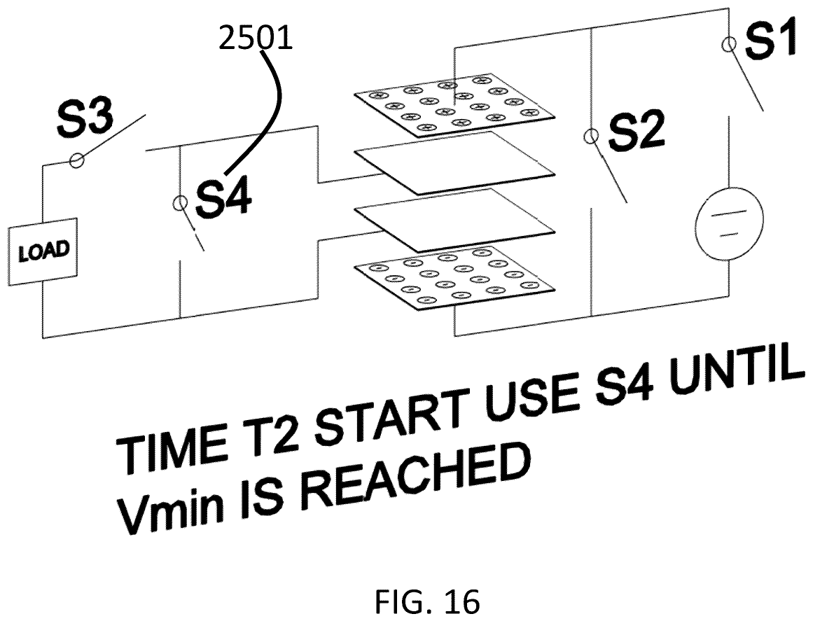

FIG. 16 illustrates an expanded control circuit configuration that includes an initial charging switch S4 connected to a charging circuit 2501. The initial charging switch S4 provides controlled initial charging capability before normal cycling operation begins through the outer charging switch S1, outer discharge switch S2, and inner capacitor switch S3. The charging circuit 2501 connects through the initial charging switch S4 to provide a controlled initial charge to bring the inner capacitor plates to a minimum system voltage before transitioning to cyclic operation.

The control switches operate in sequential timing to coordinate the charging and discharging cycles. The outer charging switch S1 closes first to charge the outer capacitor plates 2201 using the power source 2207. After the outer capacitor plates 2201 reach full charge, the outer charging switch S1 opens and the inner capacitor switch S3 closes to allow the inner capacitor plates 2202 to charge using the electric field generated by the outer capacitor plates 2201. The outer discharge switch S2 then closes to discharge the outer capacitor plates 2201, followed by the inner capacitor switch S3 enabling discharge of the inner capacitor plates 2202 through the electrical load 2206.

The control circuit includes NMOS and PMOS field effect transistors (FETs) for switching control operations. The NMOS FETs provide switching control for certain charging and discharging functions while the PMOS FETs manage other switching operations within the control circuit. The FETs enable precise timing control of the charging and discharging sequences through electronic switching rather than mechanical switch contacts.

In some implementations, the outer charging switch S1 may be implemented using NMOS FET technology to provide rapid switching response for outer capacitor charging operations. In some implementations, the outer discharge switch S2 may utilize PMOS FET technology to enable controlled discharge of the outer capacitor plates 2201. In some implementations, the inner capacitor switch S3 may incorporate both NMOS and PMOS FETs to manage bidirectional current flow during charging and discharging of the inner capacitor plates 2202.

In some implementations, the initial charging switch S4 may include current limiting features to prevent excessive current flow during initial charging operations. In some implementations, the charging circuit 2501 may incorporate voltage regulation to maintain stable charging conditions during initial system startup. In some implementations, the control switches may include protection features to prevent damage from overcurrent or overvoltage conditions during operation.

In some implementations, the control switches may be implemented using solid-state switching devices other than FETs, such as bipolar junction transistors or insulated gate bipolar transistors. In some implementations, the switching timing may be controlled by analog timing circuits rather than digital control systems. In some implementations, the control switches may incorporate feedback sensing to monitor current and voltage levels during switching operations.

FIG. 18 shows the circuit assembly 2700 with control pins for managing capacitor charging and discharging operations. The circuit assembly 2700 includes a control pin E 2701 connected to switching transistors for controlling outer capacitor charging operations. A control pin J 2702 connects to switching circuitry for managing inner capacitor charging functions. The circuit assembly 2700 incorporates a circuit point A 2704 that provides a voltage sensing location within the assembly for monitoring electrical parameters during operation.

The circuit assembly 2700 includes a control pin G1 2705 and a control pin G2 2706 configured to control current flow through rectifying circuit arms during inner capacitor charging operations. A control pin H1 2711 and a control pin H2 2712 manage current flow direction through the circuit assembly 2700 during inner capacitor discharging operations. The circuit assembly 2700 incorporates a control pin B 2713 that provides an additional control point for circuit operation and voltage sensing functions.

The control pin E 2701 sends signals to NMOS field effect transistors to enable current flow from the power source to the outer capacitor plates when activated. The control pin J 2702 sends signals to PMOS field effect transistors to initiate inner capacitor charging through the limiting resistor 2703 when the outer capacitor plates generate the electric field. The circuit point A 2704 enables voltage sensing across the limiting resistor 2703 to monitor when target voltage levels are reached during initial charging operations.

The control pin G1 2705 and the control pin G2 2706 send signals to PMOS field effect transistors that switch inner capacitor charging current to flow through rectifying circuit arms and the electrical load 2707 along with the smoothing capacitor 2708. The control pin H1 2711 and the control pin H2 2712 send signals to NMOS field effect transistors to enable inner capacitor discharge current flow in the opposite direction through the circuit assembly 2700 while maintaining current flow direction across the electrical load 2707.

FIG. 23 shows the microprocessor 3201 with input and output pins arranged around the perimeter for controlling the circuit assembly 2700 operations. The microprocessor 3201 includes analog to digital voltage sensor input pins for monitoring voltage levels at various circuit points including the circuit point A 2704 and the control pin B 2713. The microprocessor 3201 incorporates digital control input and output pins that connect to the control pin E 2701, the control pin J 2702, the control pin G1 2705, the control pin G2 2706, the control pin H1 2711, and the control pin H2 2712 for managing switching operations.

The microprocessor 3201 processes signals from voltage sensing inputs to monitor the voltage across the limiting resistor 2703 and determine when charging operations reach target voltage levels. The microprocessor 3201 generates control signals for the control pins to manage the timing of charging and discharging cycles through sequential activation of field effect transistors connected to each control pin. The microprocessor 3201 maintains the voltage of the inner capacitor plates within a specified range by monitoring voltage readings and controlling switch timing to prevent overvoltage or undervoltage conditions.

The microprocessor 3201 counts the number of charging and discharging cycles completed by the circuit assembly 2700 and tracks changes in charging time to monitor system health. The microprocessor 3201 calculates the time required for each charging cycle and compares the charging time to initial baseline measurements to detect performance degradation. The microprocessor 3201 provides warning signals when the number of cycles reaches predetermined thresholds at one-quarter, one-half, and three-quarters of the expected cycle life to alert users for maintenance requirements.

The microprocessor 3201 includes voltage sensing capabilities that monitor output voltage across circuit points to maintain minimum and maximum voltage ranges during operation. The microprocessor 3201 reads voltage levels between circuit points and compares the readings to programmed voltage thresholds to determine when to activate or deactivate control pins for charging and discharging operations. The microprocessor 3201 implements time delays based on circuit time constants to allow complete charging and discharging of capacitor components before transitioning between operational states.

The control circuit coordinates charging of the outer capacitor plates using the power source through activation of the control pin E 2701 that enables current flow from the power source to the outer capacitor plates. The control circuit manages charging of the inner capacitor plates using the electric field generated by the outer capacitor plates through sequential activation of the control pin J 2702 and the control pin G1 2705 with the control pin G2 2706 that direct current flow through the inner capacitor plates. The control circuit controls discharge of the inner capacitor plates through the electrical load 2707 by activating the control pin H1 2711 and the control pin H2 2712 that enable current flow from the inner capacitor plates through the electrical load 2707.

In some implementations, the microprocessor 3201 may incorporate additional analog to digital converter channels for monitoring voltage and current at multiple circuit points simultaneously. In some implementations, the microprocessor 3201 may include digital signal processing capabilities for analyzing charging and discharging waveforms to optimize timing parameters. In some implementations, the control pins may incorporate current sensing capabilities to monitor current flow through each switching path during operation.

In some implementations, the microprocessor 3201 may include communication interfaces for transmitting operational data to external monitoring systems or user interfaces. In some implementations, the voltage sensing capabilities may include programmable gain amplifiers to accommodate different voltage ranges during operation. In some implementations, the microprocessor 3201 may incorporate non-volatile memory for storing cycle count data and performance history information.

In some implementations, the control circuit may include additional protection features such as overcurrent detection and thermal monitoring to prevent damage during operation. In some implementations, the microprocessor 3201 may implement adaptive timing algorithms that adjust charging and discharging periods based on measured system performance. In some implementations, the control pins may include isolation circuitry to protect the microprocessor 3201 from high voltage or current transients during switching operations.

FIG. 16 shows the charging circuit 2501 connected through the initial charging switch S4 to provide controlled initial charging capability. The initial charging switch S4 enables the charging circuit 2501 to charge the inner capacitor plates to a minimum system voltage before normal cycling operation begins through the outer charging switch S1, the outer discharge switch S2, and the inner capacitor switch S3. The charging circuit 2501 includes current limiting features to maintain current levels within operating limits during initial charging operations.

The initial charging switch S4 connects the charging circuit 2501 to the inner capacitor plates to establish a minimum voltage level before the system transitions to cyclic operation. The charging circuit 2501 incorporates a current limiting resistor to prevent excessive current flow during initial charging of the inner capacitor plates. The current limiting resistor within the charging circuit 2501 regulates current flow to maintain safe operating levels for the capacitor components during startup operations.

FIG. 18 depicts the circuit assembly 2700 with the limiting resistor 2703 positioned to regulate current flow during charging operations. The limiting resistor 2703 connects between the power source and the inner capacitor plates to control current levels when the control pin J 2702 activates the charging sequence. The limiting resistor 2703 prevents excessive current flow that could damage the inner capacitor plates or other circuit components during charging operations.

The circuit assembly 2700 includes the smoothing capacitor 2708 connected in parallel with the electrical load 2707. The smoothing capacitor 2708 operates alongside the electrical load 2707 to maintain steady voltage levels during energy delivery operations. The smoothing capacitor 2708 stores electrical energy to reduce voltage fluctuations across the electrical load 2707 during charging and discharging transitions. The parallel connection of the smoothing capacitor 2708 with the electrical load 2707 provides voltage stabilization that maintains consistent power delivery characteristics throughout the operational cycle.

The circuit assembly 2700 incorporates a discharge resistor 2710 to facilitate controlled discharge of the outer capacitor plates. The discharge resistor 2710 connects across the outer capacitor plates through switching circuitry controlled by the control pin F. The discharge resistor 2710 provides a current-limited discharge path for the outer capacitor plates when the control circuit activates the discharge sequence. The discharge resistor 2710 regulates the discharge current to prevent damage to circuit components while enabling complete discharge of the outer capacitor plates within the specified time period.

The circuit assembly 2700 includes rectifying circuit arms that enable current flow in controlled directions during charging and discharging operations. The control pin G1 2705 and the control pin G2 2706 manage current flow through the rectifying circuit arms during inner capacitor charging operations. The control pin H1 2711 and the control pin H2 2712 control current flow through opposite rectifying circuit arms during inner capacitor discharging operations. The rectifying circuit arms maintain consistent current flow direction across the electrical load 2707 while allowing bidirectional current flow through the inner capacitor plates during charging and discharging cycles.

The rectifying bridge circuit formed by the rectifying circuit arms enables DC operation by maintaining unidirectional current flow through the electrical load 2707. The rectifying bridge circuit allows the inner capacitor plates to charge and discharge through different current paths while maintaining the same current flow direction across the electrical load 2707. The rectifying bridge circuit coordinates with the smoothing capacitor 2708 to provide stable DC power delivery to the electrical load 2707 throughout the charging and discharging cycles.

In some implementations, the limiting resistor 2703 may have resistance values selected to limit charging current to specific amperage levels based on the current handling capabilities of the inner capacitor plates. In some implementations, the smoothing capacitor 2708 may have capacitance values chosen to minimize voltage ripple across the electrical load 2707 during switching transitions. In some implementations, the discharge resistor 2710 may incorporate temperature compensation features to maintain consistent discharge characteristics across different operating temperatures.

In some implementations, the charging circuit 2501 may include additional voltage regulation circuitry to maintain stable charging conditions during initial system startup. In some implementations, the rectifying circuit arms may incorporate diode elements or synchronous switching to achieve efficient current rectification. In some implementations, multiple limiting resistors may be used in different circuit paths to provide independent current control for charging and discharging operations.

In some implementations, the smoothing capacitor 2708 may be implemented using multiple capacitors connected in parallel to achieve desired capacitance values and current handling capabilities. In some implementations, the discharge resistor 2710 may include switching elements to provide variable resistance values for different discharge rates. In some implementations, the current limiting features may incorporate active current control circuits rather than passive resistive elements to provide more precise current regulation.

FIGS. 19A and 19B show the single stack assembly 2801 with conductive leads extending from the capacitor structure. The conductive leads connect to each of the conductive foils 2803 within the single stack assembly 2801 to provide electrical connections for the outer capacitor plates 2802 and the inner capacitor plates 2805. The conductive leads extend outward from the single stack assembly 2801 at offset positions to maintain electrical isolation between the different capacitor elements.

The single stack assembly 2801 incorporates a vacuum sealed pouch that encloses the capacitor components while allowing the conductive leads to protrude through the pouch edge. The vacuum sealed pouch provides environmental protection and containment for the outer capacitor plates 2802, the inner capacitor plates 2805, the dielectric films 2804, and the electrolyte membrane 2807 within the single stack assembly 2801. The vacuum sealed pouch maintains the structural integrity of the capacitor sandwich 2806 by removing air and creating a sealed environment around the internal components.

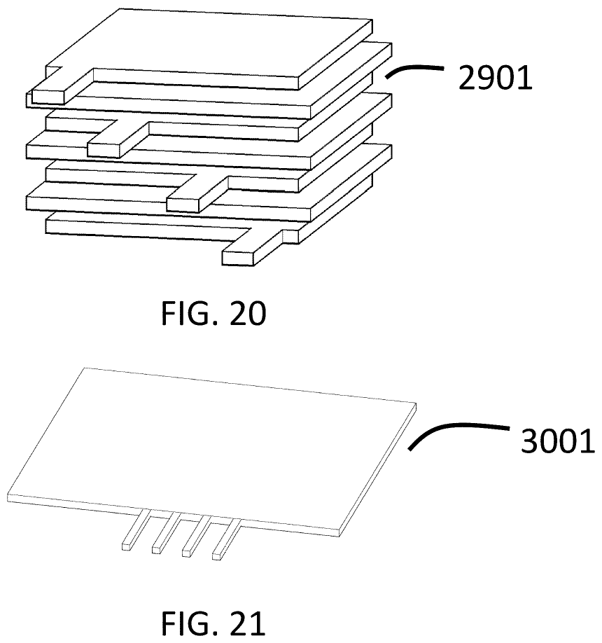

FIGS. 20 and 21 show the detailed construction of the conductive leads 2901 and vacuum sealed pouch 3001 within the single stack assembly. The conductive leads 2901 extend from each of the conductive foils 2803 to provide electrical connections for both the outer capacitor plates 2802 and the inner capacitor plates 2805. The conductive leads 2901 are positioned at offset locations to prevent electrical contact between leads connected to different capacitor elements within the assembly.

The vacuum sealed pouch 3001 encases the entire capacitor structure including the outer capacitor plates 2802, inner capacitor plates 2805, dielectric films 2804, and electrolyte membrane 2807. The vacuum sealed pouch 3001 maintains a sealed environment around the internal components while allowing the conductive leads 2901 to penetrate through designated exit points. The sealing process removes air from around the components to eliminate air gaps that could affect electrical performance.

The conductive leads 2901 connect to tabs that extend from each conductive foil 2803 layer within the single stack assembly 2801. The tabs provide secure attachment points for the conductive leads 2901 while maintaining electrical isolation between different capacitor elements. The conductive leads 2901 may be constructed from copper wire or other conductive materials to provide low resistance electrical pathways.

The vacuum sealed pouch 3001 may be constructed from plastic materials that provide moisture barrier properties and mechanical durability. The pouch creates multiple seal points around the conductive leads 2901 to maintain environmental protection while preserving electrical isolation. The vacuum sealing process may include inert gas backfilling to provide additional protection for the internal components during operation.

The offset arrangement of the conductive leads 2901 enables proper identification and connection to external control circuitry. The conductive leads 2901 may incorporate strain relief features to prevent mechanical stress on the electrical connections during handling and installation. The leads may include identification markings to facilitate correct connection to the power source 2207, electrical load 2206, and control circuit components during system assembly.

The conductive leads extend past the vacuum sealed pouch edge to enable connection to external control circuitry. The conductive leads provide electrical pathways for connecting the outer capacitor plates 2802 to the power source and control switches. The conductive leads also enable connection of the inner capacitor plates 2805 to the electrical load and control circuitry for charging and discharging operations. The offset arrangement of the conductive leads prevents electrical contact between leads connected to different capacitor elements within the single stack assembly 2801.

The single stack assembly 2801 may be mounted on a heat sink such as an aluminum plate with adhesive to provide thermal management during operation. The aluminum plate heat sink conducts heat away from the single stack assembly 2801 to maintain suitable temperature ranges for preserving the physical properties of the dielectric films 2804 and the electrolyte membrane 2807. The adhesive connection between the single stack assembly 2801 and the aluminum plate heat sink enables efficient thermal transfer while maintaining mechanical stability of the assembly.

The vacuum sealed pouch creates a sealed environment that protects the internal components from moisture, contamination, and atmospheric exposure. The vacuum sealed pouch maintains the positioning of the outer capacitor plates 2802, the inner capacitor plates 2805, the dielectric films 2804, and the electrolyte membrane 2807 within the capacitor sandwich 2806 configuration. The vacuum sealing process removes air from around the components to eliminate air gaps that could affect the electrical performance of the single stack assembly 2801.

The conductive leads attach to tabs connected to each of the conductive foils 2803 to provide secure electrical connections. The tabs extend from the conductive foils 2803 and connect to the conductive leads at positions that allow the leads to exit the vacuum sealed pouch without compromising the seal integrity. The tab connections enable reliable electrical contact between the conductive leads and the outer capacitor plates 2802 and the inner capacitor plates 2805 throughout the operational cycles of the single stack assembly 2801.

In some implementations, the conductive leads may be constructed from copper wire to provide low resistance electrical connections. In some implementations, the conductive leads may incorporate insulation coatings to prevent electrical contact between adjacent leads during assembly and operation. In some implementations, the vacuum sealed pouch may be constructed from plastic materials that provide moisture barrier properties and mechanical durability.

In some implementations, the heat sink may be constructed from materials other than aluminum, such as copper or thermally conductive ceramics, to provide enhanced thermal management capabilities. In some implementations, the adhesive connection may incorporate thermal interface materials to improve heat transfer between the single stack assembly 2801 and the heat sink. In some implementations, multiple single stack assemblies may be mounted on a common heat sink to provide thermal management for arrays of capacitor stacks.

In some implementations, the vacuum sealed pouch may incorporate multiple seal points around the conductive leads to ensure environmental protection while maintaining electrical isolation. In some implementations, the vacuum sealing process may include inert gas backfilling to provide additional protection for the internal components. In some implementations, the vacuum sealed pouch may include pressure relief features to accommodate thermal expansion of internal components during operation.

In some implementations, the tabs connected to the conductive foils 2803 may be welded or soldered to provide permanent electrical connections. In some implementations, the conductive leads may incorporate strain relief features to prevent mechanical stress on the electrical connections during handling and installation. In some implementations, the conductive leads may include identification markings to facilitate proper connection to external circuitry during system assembly.

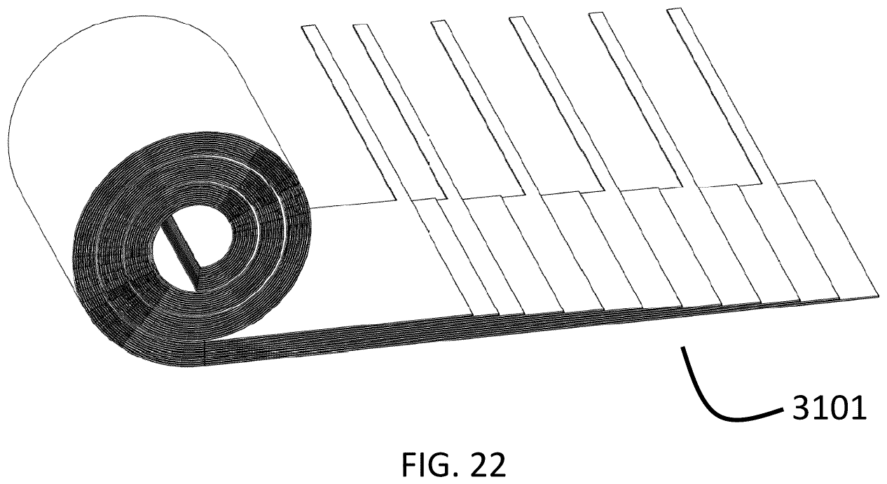

FIG. 22 illustrates a cylindrical roll assembly 3101 that provides an alternative embodiment for packaging the capacitor layers. The cylindrical roll assembly 3101 shows a rolled configuration where the outer capacitor plates, the inner capacitor plates, the dielectric films, and the electrolyte membrane are wound together to form a cylindrical structure. The cylindrical roll assembly 3101 demonstrates how the capacitor foils, dielectric films, and electrolyte separator membranes are rolled into a cylindrical sandwich assembly that creates a compact form factor.

The cylindrical roll assembly 3101 incorporates the same layered components as the single stack assembly but arranges the components in a spiral configuration rather than a flat stack arrangement. The outer capacitor plates formed from the conductive foils are positioned as outer layers within the cylindrical roll assembly 3101. The inner capacitor plates with activated carbon or graphene coatings are positioned as inner layers within the rolled structure. The dielectric films provide electrical isolation between the outer capacitor plates and the inner capacitor plates throughout the rolled configuration. The electrolyte membrane maintains ionic conduction between the inner capacitor plates while the components are arranged in the cylindrical roll assembly 3101.

The cylindrical roll assembly 3101 can be housed in a can housing with a sealed lid. The can housing provides mechanical protection and environmental containment for the rolled capacitor components within the cylindrical roll assembly 3101. The sealed lid of the can housing maintains the internal environment of the cylindrical roll assembly 3101 while providing access points for electrical connections. The can housing and sealed lid combination creates a robust enclosure that protects the cylindrical roll assembly 3101 from moisture, contamination, and mechanical damage during operation.

Each of the conductive foils within the cylindrical roll assembly 3101 includes at least one tab that penetrates through the sealed lid of the can housing. The tabs provide electrical connections for the outer capacitor plates and the inner capacitor plates to enable connection to external control circuitry. The tabs extend through the sealed lid to maintain electrical access while preserving the environmental protection provided by the can housing. The tab connections enable the cylindrical roll assembly 3101 to interface with the power source, the electrical load, and the control circuit components for charging and discharging operations.

In some implementations, the cylindrical roll assembly 3101 may include a central core made of aluminum or other thermally conductive material for heat removal. The aluminum central core provides thermal conduction pathways that remove heat from the interior of the cylindrical roll assembly 3101 during charging and discharging operations. The thermally conductive central core maintains temperature control within the cylindrical roll assembly 3101 to preserve the material properties of the dielectric films and the electrolyte membrane throughout operational cycles. The central core enables efficient heat transfer from the rolled capacitor components to external heat dissipation systems.

In some implementations, the can housing may be constructed from aluminum or other conductive materials to provide electromagnetic shielding for the cylindrical roll assembly 3101. In some implementations, the sealed lid may incorporate multiple penetration points for tabs connected to different layers within the cylindrical roll assembly 3101. In some implementations, the central core may include cooling channels or fins to enhance heat dissipation capabilities.

In some implementations, the cylindrical roll assembly 3101 may incorporate separator materials between rolled layers to maintain proper spacing and prevent electrical contact between adjacent conductive surfaces. In some implementations, the rolling process may include tension control to maintain consistent layer spacing throughout the cylindrical roll assembly 3101. In some implementations, the cylindrical roll assembly 3101 may include end caps or termination structures to secure the rolled layers and prevent unwinding during operation.

In some implementations, the can housing may include pressure relief features to accommodate thermal expansion of the cylindrical roll assembly 3101 during operation. In some implementations, the sealed lid may incorporate hermetic sealing techniques to maintain the internal environment of the cylindrical roll assembly 3101. In some implementations, the tabs may include strain relief features to prevent mechanical stress on the electrical connections during thermal cycling.

FIG. 24 illustrates the mechanical assembly 3301 with multiple capacitor stacks arranged within the housing body 3307. The mechanical assembly 3301 includes a plurality of capacitor stacks 3305 positioned in a parallel configuration below the control board 3304. Each capacitor stack 3305 comprises an outer capacitor and an inner capacitor embedded within the outer capacitor, similar to the single stack assembly 2801 described previously. The capacitor stacks 3305 are arranged to enable connection in series configurations, parallel configurations, or combinations thereof to meet specific voltage and current requirements for different applications.

The capacitor stacks 3305 within the mechanical assembly 3301 connect to the control board 3304 through electrical connections that enable coordinated charging and discharging operations. The control board 3304 incorporates the microprocessor 3201 and associated control circuitry for managing the charging and discharging cycles of the multiple capacitor stacks 3305. The power supply 3306 connects to the outer capacitor plates of each capacitor stack 3305 to provide charging capability for the outer capacitor components within each stack.

The plurality of capacitor stacks 3305 may be arranged in a series configuration to increase the total voltage output of the mechanical assembly 3301. When the capacitor stacks 3305 are connected in series, the voltage outputs of individual stacks add together while the current capacity remains equivalent to a single capacitor stack 3305. The series configuration enables the mechanical assembly 3301 to achieve higher voltage levels than would be possible with a single capacitor stack 3305 operating alone.

The plurality of capacitor stacks 3305 may be arranged in a parallel configuration to increase the total current output of the mechanical assembly 3301. When the capacitor stacks 3305 are connected in parallel, the current outputs of individual stacks add together while the voltage output remains equivalent to a single capacitor stack 3305. The parallel configuration enables the mechanical assembly 3301 to deliver higher current levels than would be possible with a single capacitor stack 3305 operating independently.

The plurality of capacitor stacks 3305 may be arranged in a combination of series and parallel configurations to achieve both increased voltage and increased current output simultaneously. The combination arrangement connects groups of capacitor stacks 3305 in series to form series strings, with multiple series strings connected in parallel to create a series-parallel array. The series-parallel configuration enables the mechanical assembly 3301 to meet specific voltage and current requirements by adjusting the number of capacitor stacks 3305 in each series string and the number of parallel series strings within the array.

The arrangement of the capacitor stacks 3305 addresses the voltage limitations of supercapacitor technology where individual capacitor stacks have voltage limits of 2.5 volts for aqueous electrolytes, 2.8 volts for organic electrolytes, or 3.0 volts for ionic liquids. The series configuration of multiple capacitor stacks 3305 enables the mechanical assembly 3301 to achieve voltage levels significantly higher than the individual voltage limits of each capacitor stack 3305. The parallel configuration of multiple capacitor stacks 3305 enables the mechanical assembly 3301 to deliver current levels that exceed the current capacity of individual capacitor stacks 3305.

The mechanical assembly 3301 may be designed to meet specific voltage and current requirements such as 400 amps at 25 volts for electric vehicle applications. The combination of series and parallel arrangements of the capacitor stacks 3305 enables the mechanical assembly 3301 to achieve the 25-volt requirement through series connection of multiple capacitor stacks 3305 while achieving the 400-amp requirement through parallel connection of multiple series strings. The modular nature of the capacitor stacks 3305 allows the mechanical assembly 3301 to be configured for different voltage and current specifications by adjusting the series and parallel arrangements.

The control board 3304 coordinates the charging and discharging operations of the multiple capacitor stacks 3305 to maintain synchronized operation across the series and parallel arrangements. The control board 3304 incorporates switching circuitry that manages the timing of charging and discharging cycles for each capacitor stack 3305 within the array. The microprocessor 3201 on the control board 3304 monitors voltage levels across individual capacitor stacks 3305 and across the combined series-parallel array to maintain operation within specified voltage ranges.

The display panel 3303 integrated into the enclosure lid 3302 provides visual information about the operation of the multiple capacitor stacks 3305 within the mechanical assembly 3301. The display panel 3303 shows voltage levels, current outputs, and charging status for the combined array of capacitor stacks 3305. The display panel 3303 also indicates the number of completed charging and discharging cycles for the mechanical assembly 3301 and provides warning signals when individual capacitor stacks 3305 or the overall array approaches operational limits.

In some implementations, the plurality of capacitor stacks 3305 may include different numbers of stacks arranged in series to achieve different voltage levels for various applications. In some implementations, the plurality of capacitor stacks 3305 may include different numbers of parallel strings to achieve different current capacities for specific load requirements. In some implementations, the mechanical assembly 3301 may incorporate switching circuitry that enables reconfiguration of the series and parallel arrangements during operation to optimize performance for changing load conditions.

In some implementations, the capacitor stacks 3305 may be individually replaceable within the mechanical assembly 3301 to enable maintenance and replacement of individual stacks without affecting the operation of other stacks in the array. In some implementations, the control board 3304 may include individual monitoring circuits for each capacitor stack 3305 to track performance and cycle life of individual stacks within the array. In some implementations, the power supply 3306 may include voltage regulation circuitry to maintain consistent charging voltage across all capacitor stacks 3305 in the parallel arrangement.

In some implementations, the mechanical assembly 3301 may include thermal management systems that distribute heat dissipation across the multiple capacitor stacks 3305 to maintain uniform operating temperatures. In some implementations, the housing body 3307 may include ventilation features or cooling systems to manage the thermal output of the multiple capacitor stacks 3305 during high-current operation. In some implementations, the capacitor stacks 3305 may include individual thermal sensors that provide temperature feedback to the control board 3304 for thermal management purposes.

In some implementations, the series and parallel arrangements may be configured to provide redundancy where failure of individual capacitor stacks 3305 does not disable the entire mechanical assembly 3301. In some implementations, the control board 3304 may include fault detection circuitry that identifies malfunctioning capacitor stacks 3305 and isolates the malfunctioning stacks from the array while maintaining operation of functional stacks. In some implementations, the mechanical assembly 3301 may include bypass switching that enables continued operation with reduced capacity when individual capacitor stacks 3305 require maintenance or replacement.

FIG. 24 illustrates the mechanical assembly 3301 that provides structural containment and organization for the capacitor system components. The mechanical assembly 3301 includes the housing body 3307 that forms the main enclosure structure for containing and protecting the internal components. The housing body 3307 provides a protective environment that shields the internal components from environmental factors while maintaining structural integrity during operation.

The housing body 3307 contains the plurality of capacitor stacks 3305 arranged within the internal volume of the mechanical assembly 3301. The capacitor stacks 3305 are positioned in a systematic arrangement that enables electrical connections while maintaining proper spacing between individual stacks. The housing body 3307 accommodates the physical dimensions of the capacitor stacks 3305 while providing adequate clearance for thermal expansion and electrical connections during operation.

The mechanical assembly 3301 includes the control board 3304 positioned above the capacitor stacks 3305 within the housing body 3307. The control board 3304 contains the electronic circuitry for managing the charging and discharging operations of the capacitor stacks 3305. The control board 3304 incorporates the microprocessor 3201 and associated switching components that coordinate the timing and sequencing of capacitor operations throughout the system cycles.

The power supply 3306 is positioned adjacent to the capacitor stacks 3305 within the housing body 3307. The power supply 3306 provides electrical energy for charging the outer capacitor plates within each of the capacitor stacks 3305. The power supply 3306 connects to the control board 3304 through electrical pathways that enable coordinated power delivery to the capacitor stacks 3305 during charging operations.

The enclosure lid 3302 fits onto the housing body 3307 to complete the protective enclosure for the mechanical assembly 3301. The enclosure lid 3302 secures the internal components within the housing body 3307 while providing access to external interfaces. The enclosure lid 3302 maintains the environmental protection of the internal components while enabling user interaction with the system through integrated interface elements.

The display panel 3303 is integrated into the enclosure lid 3302 to provide visual information about the operation of the mechanical assembly 3301. The display panel 3303 shows operational parameters including voltage levels, charging status, and cycle counts for the capacitor stacks 3305 within the housing body 3307. The display panel 3303 receives control signals from the control board 3304 to update the displayed information based on the operational state of the capacitor system.

The housing body 3307 provides mechanical protection for the capacitor stacks 3305, the control board 3304, and the power supply 3306 against physical damage during handling and operation. The housing body 3307 maintains the positioning of the internal components to preserve electrical connections and prevent mechanical interference between components. The housing body 3307 incorporates mounting features that secure the capacitor stacks 3305 and the control board 3304 in fixed positions within the mechanical assembly 3301.

The enclosure lid 3302 creates a sealed environment when attached to the housing body 3307 that protects the internal components from moisture, dust, and other environmental contaminants. The enclosure lid 3302 maintains the internal environment of the mechanical assembly 3301 while providing thermal management pathways for heat dissipation from the capacitor stacks 3305 and the control board 3304 during operation.

In some implementations, the housing body 3307 may be constructed from aluminum materials to provide electromagnetic shielding for the internal components. In some implementations, the housing body 3307 may incorporate ventilation features or cooling channels to enhance thermal management of the capacitor stacks 3305 during high-current operation. In some implementations, the housing body 3307 may include mounting brackets or attachment points for installation in various applications.

In some implementations, the enclosure lid 3302 may incorporate gasket sealing to provide environmental protection against moisture and contamination. In some implementations, the enclosure lid 3302 may include access ports or connectors for external electrical connections to the capacitor system. In some implementations, the enclosure lid 3302 may incorporate thermal interface materials to facilitate heat transfer from the internal components to external heat dissipation systems.

In some implementations, the display panel 3303 may incorporate touchscreen functionality to enable user input for system configuration and control. In some implementations, the display panel 3303 may include LED indicators or other visual elements to provide status information about the operational state of the capacitor stacks 3305. In some implementations, the display panel 3303 may connect to external communication interfaces for remote monitoring and control of the mechanical assembly 3301.

In some implementations, the mechanical assembly 3301 may include shock absorption features within the housing body 3307 to protect the capacitor stacks 3305 from mechanical vibration and impact during operation. In some implementations, the mechanical assembly 3301 may incorporate modular design features that enable replacement or upgrade of individual components without disassembly of the entire housing structure. In some implementations, the mechanical assembly 3301 may include cable management systems within the housing body 3307 to organize electrical connections between the capacitor stacks 3305, the control board 3304, and the power supply 3306.

The display panel 3303 integrated into the enclosure lid 3302 provides visual information about the operation of the mechanical assembly 3301. The display panel 3303 shows voltage levels across the capacitor stack 3305 components during charging and discharging operations. The display panel 3303 displays charging status information that indicates whether the outer capacitor plates and the inner capacitor plates are in charging, charged, discharging, or discharged states throughout the operational cycles.

The display panel 3303 presents cycle count information that tracks the number of completed charging and discharging cycles performed by the capacitor stack 3305 within the mechanical assembly 3301. The cycle count display enables monitoring of the operational history of the capacitor stack 3305 to assess system usage and remaining operational life. The display panel 3303 receives control signals from the control board 3304 that contains the microprocessor 3201 for updating the displayed information based on real-time system measurements.

The display panel 3303 shows voltage level readings that correspond to measurements taken at various circuit points within the circuit assembly 2700. The voltage level display includes readings from the outer capacitor plates and the inner capacitor plates to provide comprehensive voltage monitoring across both capacitor components. The display panel 3303 updates the voltage level information continuously during operation to reflect the changing voltage conditions throughout the charging and discharging cycles.

The charging status display on the display panel 3303 indicates the operational state of the outer charging switch S1, the outer discharge switch S2, and the inner capacitor switch S3 during system operation. The charging status information shows when the power supply 3306 is actively charging the outer capacitor plates through the outer charging switch S1. The display panel 3303 also indicates when the inner capacitor plates are charging using the electric field generated by the outer capacitor plates and when the inner capacitor plates are discharging through the electrical load 2707.

The cycle count display on the display panel 3303 increments each time the capacitor stack 3305 completes a full charging and discharging cycle. The cycle count information enables tracking of the total operational cycles performed by the mechanical assembly 3301 throughout the operational lifetime. The display panel 3303 receives cycle count updates from the microprocessor 3201 that monitors the completion of each operational cycle and maintains the cumulative cycle count in memory.

The display panel 3303 connects to the control board 3304 through electrical connections that enable data transfer from the microprocessor 3201 to the display components. The electrical connections carry digital signals that control the display elements within the display panel 3303 to show the voltage levels, charging status, and cycle count information. The display panel 3303 receives power from the control board 3304 to operate the display elements and maintain visibility of the operational information.

The display panel 3303 incorporates visual elements that present the operational information in a readable format for users of the mechanical assembly 3301. The visual elements include numeric displays for voltage levels and cycle counts along with status indicators for charging and discharging states. The display panel 3303 organizes the visual elements to provide clear presentation of the multiple operational parameters simultaneously during system operation.

In some implementations, the display panel 3303 may incorporate liquid crystal display technology to provide numeric and text-based information about system operation. In some implementations, the display panel 3303 may include light-emitting diode indicators that provide color-coded status information for different operational states. In some implementations, the display panel 3303 may incorporate touchscreen functionality to enable user input for system configuration and control parameters.

In some implementations, the display panel 3303 may show additional operational parameters such as current flow levels through the electrical load 2707 during charging and discharging operations. In some implementations, the display panel 3303 may display temperature information from thermal sensors within the capacitor stack 3305 to provide thermal monitoring capabilities. In some implementations, the display panel 3303 may include warning indicators that activate when voltage levels, cycle counts, or other operational parameters approach predetermined threshold values.

In some implementations, the display panel 3303 may incorporate graphical display capabilities that show voltage and current waveforms similar to the charging voltage plot 2401, the discharging voltage plot 2402, and the current plot 2403. In some implementations, the display panel 3303 may include data logging capabilities that store historical operational information for analysis of system performance over time. In some implementations, the display panel 3303 may connect to external communication interfaces for remote monitoring and control of the mechanical assembly 3301.

In some implementations, the display panel 3303 may include user interface elements such as buttons or switches that enable manual control of charging and discharging operations. In some implementations, the display panel 3303 may incorporate programmable display features that allow customization of the displayed information based on user preferences or application requirements. In some implementations, the display panel 3303 may include diagnostic display modes that show detailed operational information for troubleshooting and maintenance purposes.

In some implementations, the display panel 3303 may incorporate backlighting or other illumination features to maintain visibility in various lighting conditions. In some implementations, the display panel 3303 may include contrast adjustment capabilities to optimize display visibility for different viewing angles and environmental conditions. In some implementations, the display panel 3303 may incorporate power management features that reduce power consumption during periods of inactivity while maintaining operational monitoring capabilities.

The control board 3304 shown in FIG. 24 integrates the electronic components and manages the overall system operation within the mechanical assembly 3301. The control board 3304 contains the electronic circuitry for managing the charging and discharging operations of the capacitor stacks 3305. The control board 3304 incorporates the microprocessor 3201 and associated switching components that coordinate the timing and sequencing of capacitor operations throughout the system cycles.

The control board 3304 is positioned above the capacitor stacks 3305 within the housing body 3307. The control board 3304 connects to the capacitor stacks 3305 through electrical connections that enable coordinated charging and discharging operations. The control board 3304 receives power from the power supply 3306 to operate the electronic components and maintain system functionality during operation.

The control board 3304 incorporates switching circuitry that manages the timing of charging and discharging cycles for each capacitor stack 3305 within the array. The switching circuitry on the control board 3304 includes field effect transistors that control current flow through different circuit paths during charging and discharging operations. The control board 3304 coordinates the operation of the outer charging switch, the outer discharge switch, and the inner capacitor switch for each capacitor stack 3305 within the mechanical assembly 3301.

The control board 3304 includes voltage sensing circuitry that monitors electrical parameters across the capacitor stacks 3305 during operation. The voltage sensing circuitry connects to circuit points within each capacitor stack 3305 to measure voltage levels across the outer capacitor plates and the inner capacitor plates. The control board 3304 processes the voltage measurements to determine when charging operations reach target voltage levels and when discharging operations reach minimum voltage thresholds.

The control board 3304 incorporates current control circuitry that regulates current flow during charging and discharging operations. The current control circuitry includes the limiting resistor and the discharge resistor components that regulate current levels to prevent damage to the capacitor stacks 3305. The control board 3304 manages current flow through the electrical load and the smoothing capacitor to maintain stable power delivery characteristics.

The control board 3304 includes timing control circuitry that coordinates the sequential operation of charging and discharging cycles. The timing control circuitry implements delays based on circuit time constants to allow complete charging and discharging of capacitor components before transitioning between operational states. The control board 3304 maintains synchronization across multiple capacitor stacks 3305 to ensure coordinated operation of the series and parallel arrangements.

The control board 3304 incorporates monitoring circuitry that tracks operational parameters including cycle counts and performance metrics. The monitoring circuitry counts the number of completed charging and discharging cycles for each capacitor stack 3305 and maintains cumulative cycle count information. The control board 3304 calculates charging time measurements and compares the charging time to baseline values to detect performance degradation over operational cycles.

The control board 3304 includes communication circuitry that interfaces with the display panel 3303 to provide operational information. The communication circuitry transmits voltage levels, charging status, and cycle count data to the display panel 3303 for visual presentation. The control board 3304 generates control signals that update the display elements within the display panel 3303 based on real-time system measurements.

The control board 3304 incorporates protection circuitry that monitors system parameters and activates warning signals when operational limits are approached. The protection circuitry generates warning signals when cycle counts reach predetermined thresholds or when performance parameters indicate approaching component limits. The control board 3304 activates visual indicators on the display panel 3303 to alert users when maintenance or replacement may be needed.

In some implementations, the control board 3304 may incorporate additional analog to digital converter channels for monitoring voltage and current at multiple circuit points simultaneously across different capacitor stacks 3305. In some implementations, the control board 3304 may include digital signal processing capabilities for analyzing charging and discharging waveforms to optimize timing parameters for individual capacitor stacks 3305. In some implementations, the control board 3304 may incorporate wireless communication interfaces for transmitting operational data to external monitoring systems.

In some implementations, the control board 3304 may include individual monitoring circuits for each capacitor stack 3305 to track performance and cycle life of individual stacks within the array. In some implementations, the control board 3304 may incorporate fault detection circuitry that identifies malfunctioning capacitor stacks 3305 and isolates the malfunctioning stacks from the array while maintaining operation of functional stacks. In some implementations, the control board 3304 may include bypass switching circuitry that enables continued operation with reduced capacity when individual capacitor stacks 3305 require maintenance.

In some implementations, the control board 3304 may incorporate thermal monitoring circuitry that measures temperature at various locations within the mechanical assembly 3301 to provide thermal management capabilities. In some implementations, the control board 3304 may include adaptive control algorithms that adjust charging and discharging timing based on measured temperature conditions to optimize performance across different operating environments. In some implementations, the control board 3304 may incorporate overcurrent protection circuitry that prevents damage during fault conditions.

In some implementations, the control board 3304 may include non-volatile memory for storing operational parameters, cycle count data, and performance history information for each capacitor stack 3305. In some implementations, the control board 3304 may incorporate real-time clock functionality to timestamp operational events and enable time-based analysis of system performance. In some implementations, the control board 3304 may include calibration circuitry that maintains measurement accuracy across different operating conditions and component aging.

In some implementations, the control board 3304 may incorporate modular design features that enable replacement or upgrade of individual circuit sections without replacement of the entire control board 3304. In some implementations, the control board 3304 may include test points and diagnostic interfaces that facilitate troubleshooting and maintenance procedures. In some implementations, the control board 3304 may incorporate power management circuitry that optimizes power consumption during different operational modes.

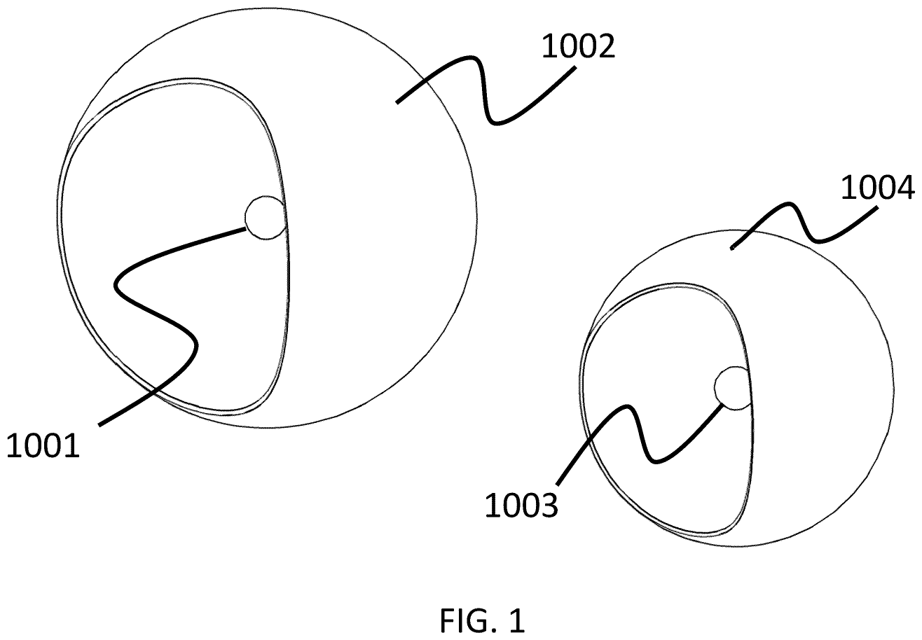

The theoretical foundation for the embedded capacitor system builds upon established principles of electrostatics and electric field interactions. FIG. 1 illustrates the fundamental charge interaction concepts that underlie the system operation. FIG. 1 shows a first point charge 1001 positioned at the center of a first hollow sphere 1002, along with a second point charge 1003 located at the center of a second hollow sphere 1004. The arrangement demonstrates how point charges interact with surrounding charge distributions in controlled configurations.

The first point charge 1001 creates an electric field that extends radially outward from the center of the first hollow sphere 1002. The first hollow sphere 1002 contains a uniformly distributed charge across the spherical surface that interacts with the first point charge 1001 at the center. The second point charge 1003 generates a similar electric field pattern within the second hollow sphere 1004. The second hollow sphere 1004 provides a spherical charge distribution that creates specific field conditions around the second point charge 1003.

The electric field generated by a hollow sphere with uniformly distributed charge exhibits zero field strength inside the sphere when the radius is less than the sphere radius, while outside the sphere the electric field behaves identically to a point charge located at the sphere center. The field characteristics enable controlled interaction between the first point charge 1001 and the second point charge 1003 when the charges are positioned at the centers of their respective hollow spheres. The zero internal field condition allows the point charges to move within the hollow spheres without experiencing force from the spherical charge distributions.

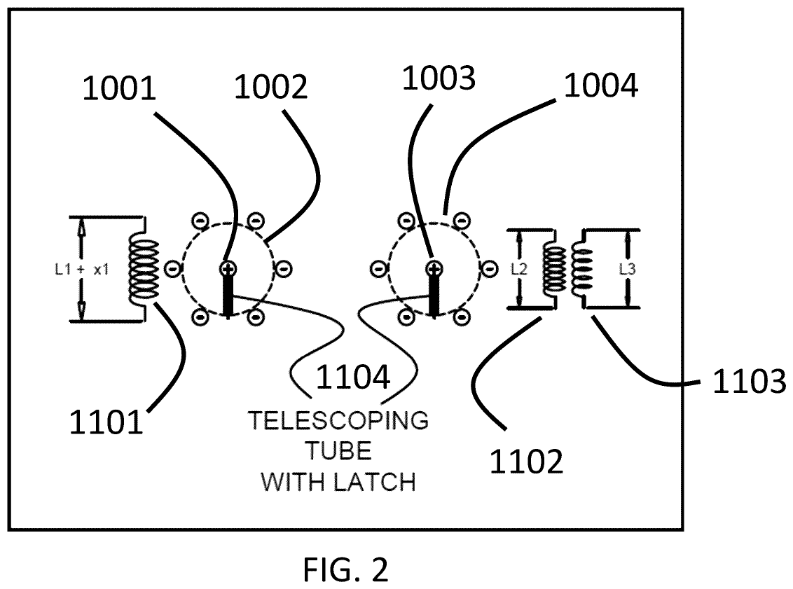

FIG. 2 shows the mechanical implementation of the charge interaction system with the first point charge 1001 and the first hollow sphere 1002 connected through mechanical linkages. The second point charge 1003 and the second hollow sphere 1004 are similarly connected through mechanical components that enable controlled movement and positioning. The mechanical system demonstrates how the theoretical charge interactions can be implemented through physical components that manipulate the relative positions of the point charges and hollow spheres.

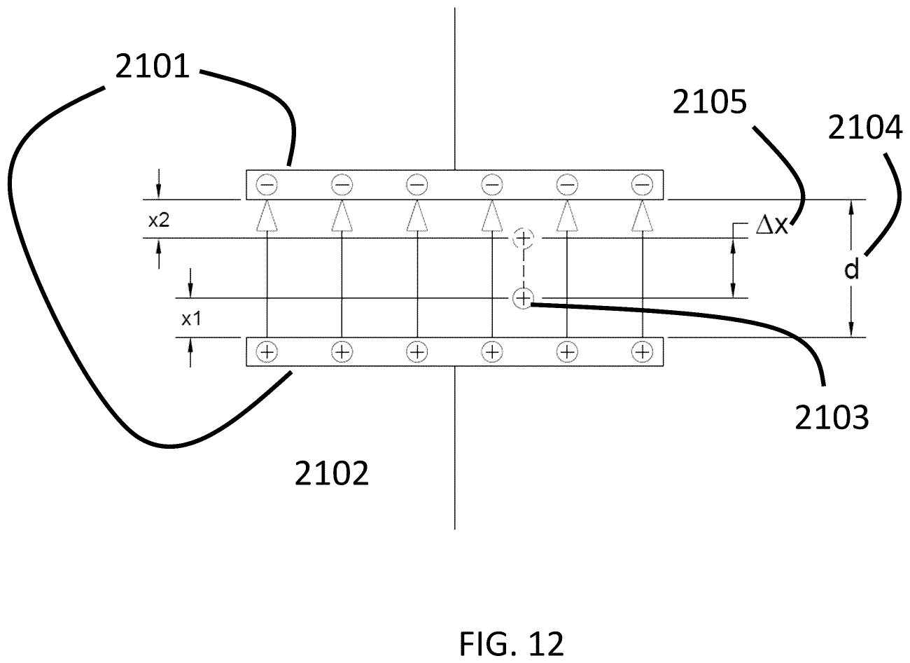

FIG. 12 illustrates the parallel plate capacitor principles that form the basis for the embedded capacitor configuration. FIG. 12 shows parallel plates 2101 separated by a plate separation distance 2104. Electric field lines 2102 extend between the parallel plates 2101 in a uniform pattern that demonstrates the electric field distribution created when voltage is applied across the parallel plates 2101. A test charge 2103 is positioned between the parallel plates 2101 to demonstrate charge behavior within the electric field environment.

The parallel plates 2101 create a uniform electric field between the conductive surfaces when a voltage difference is applied across the plates. The electric field lines 2102 point from the positive plate toward the negative plate in parallel lines that indicate uniform field strength throughout the region between the parallel plates 2101. The plate separation distance 2104 determines the electric field strength for a given applied voltage, with closer plate spacing creating stronger electric fields.

The test charge 2103 experiences a force when positioned within the electric field created by the parallel plates 2101. The test charge 2103 moves through a charge travel distance 2105 when subjected to the electric field force. The charge travel distance 2105 represents the displacement of the test charge 2103 under the influence of the electric field generated between the parallel plates 2101. The movement of the test charge 2103 demonstrates how charges respond to electric field environments created by capacitor configurations.

The voltage relationship for parallel plate capacitors follows the equation V=E×d, where V represents the voltage across the parallel plates 2101, E represents the electric field strength, and d represents the plate separation distance 2104. The electric field strength remains uniform between the parallel plates 2101 when the plates are large compared to the plate separation distance 2104. The uniform field condition enables predictable charge behavior within the capacitor structure.

The voltage drop experienced by the test charge 2103 as the test charge 2103 moves through the charge travel distance 2105 follows the relationship V_drop=Σ×Δx, where Δx represents the charge travel distance 2105 perpendicular to the electric field lines 2102. The voltage drop calculation demonstrates how charges experience potential differences when moving within electric field environments created by capacitor structures.

The embedded capacitor system applies the parallel plate capacitor principles by positioning the inner capacitor plates 2202 within the electric field region created by the outer capacitor plates 2201. The outer capacitor plates 2201 function as the parallel plates 2101 that generate the electric field environment. The inner capacitor plates 2202 operate as charge storage elements positioned within the electric field created by the outer capacitor plates 2201, similar to how the test charge 2103 responds to the electric field between the parallel plates 2101.

The electric field generated by the outer capacitor plates 2201 influences the charge distribution on the inner capacitor plates 2202 without requiring direct electrical connection between the outer and inner capacitor components. The field-based charging mechanism enables the inner capacitor plates 2202 to accumulate charge using the electric field energy created by the outer capacitor plates 2201. The embedded configuration positions the inner capacitor plates 2202 within the uniform field region between the outer capacitor plates 2201 to achieve controlled charging behavior.

The theoretical foundation demonstrates how electric field interactions enable energy transfer between capacitor components without direct electrical connection. The outer capacitor plates 2201 store energy in the electric field created between the conductive surfaces. The inner capacitor plates 2202 extract energy from the electric field environment to charge the internal capacitor structure. The field-based energy transfer mechanism enables the embedded capacitor system to operate through controlled electric field manipulation rather than conventional electrical circuit connections.

In some implementations, the point charge configurations may incorporate multiple charge distributions to create more complex field patterns for enhanced charge interaction effects. In some implementations, the hollow sphere arrangements may include variable charge densities across the spherical surfaces to modify the internal field characteristics. In some implementations, the parallel plate configurations may incorporate non-uniform plate spacing to create gradient electric fields for specialized charge manipulation applications.

In some implementations, the electric field lines 2102 may be modified through dielectric materials positioned between the parallel plates 2101 to alter field strength and distribution patterns. In some implementations, the test charge 2103 may represent multiple charge carriers that respond collectively to the electric field environment created by the parallel plates 2101. In some implementations, the charge travel distance 2105 may be controlled through external field manipulation to achieve specific charge positioning within the capacitor structure.

In some implementations, the voltage relationships may be modified through non-linear dielectric materials that alter the electric field response to applied voltages. In some implementations, the plate separation distance 2104 may be varied during operation to dynamically control electric field strength and charge interaction characteristics. In some implementations, the parallel plates 2101 may incorporate surface treatments or coatings that modify charge distribution patterns and field uniformity.

In some implementations, the embedded capacitor configuration may incorporate multiple layers of inner capacitor plates positioned at different locations within the electric field created by the outer capacitor plates. In some implementations, the field-based charging mechanism may be enhanced through resonant field configurations that amplify charge transfer efficiency between the outer and inner capacitor components. In some implementations, the electric field manipulation may include time-varying field patterns that optimize charge accumulation and energy storage characteristics.

FIG. 2 illustrates a mechanical system that demonstrates the energy storage principles underlying the capacitor system operation. The system includes the first point charge 1001 positioned at the center of the first hollow sphere 1002, and the second point charge 1003 located at the center of the second hollow sphere 1004. The mechanical arrangement incorporates a compression spring 1101 that stores mechanical energy in a compressed state. A tension spring 1102 provides elastic energy storage through stretching capabilities. A relaxed spring 1103 maintains an uncompressed state within the mechanical system. A telescoping tube 1104 enables controlled movement of the charged elements along a defined axis while maintaining mechanical connection between components.

The compression spring 1101 stores potential energy through mechanical compression from the relaxed length. The compression spring 1101 connects to the telescoping tube 1104 to enable energy transfer between the mechanical and electrical components of the system. The tension spring 1102 provides energy storage through elastic deformation when stretched beyond the natural length. The relaxed spring 1103 represents the unloaded state of the spring elements before energy storage operations begin.

The telescoping tube 1104 incorporates a latching mechanism that allows controlled positioning of the charged elements. The telescoping tube 1104 enables movement of the first point charge 1001 and the second point charge 1003 along the tube axis while maintaining mechanical connection to the spring elements. The latching mechanism within the telescoping tube 1104 fixes the charged elements in desired positions during different phases of the energy storage cycle.

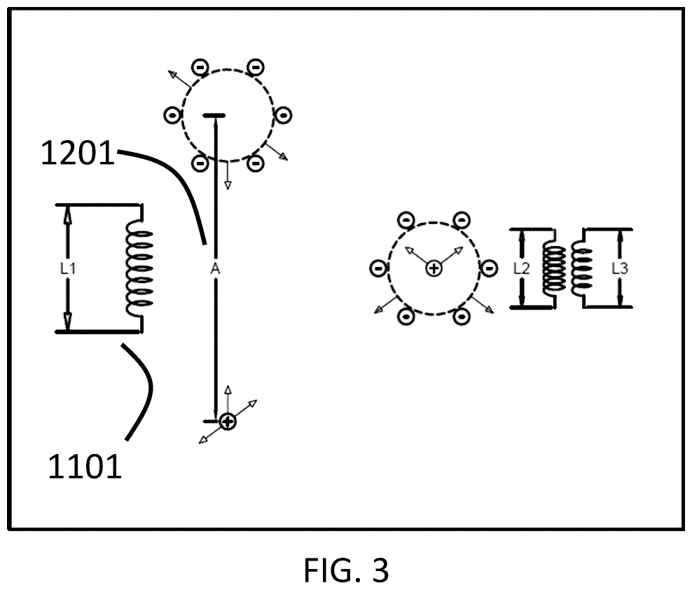

FIG. 3 shows the compression spring 1101 positioned within the mechanical system during an operational state. A separation distance 1201 indicates the spacing between charged elements when the compression spring 1101 transfers energy to separate the first point charge 1001 from the first hollow sphere 1002. The separation distance 1201 represents the displacement achieved through the mechanical energy stored in the compression spring 1101.

The compression spring 1101 provides the mechanical force to move the first point charge 1001 away from the center of the first hollow sphere 1002. The energy stored in the compression spring 1101 converts to electrostatic potential energy as the first point charge 1001 moves to the separation distance 1201 from the first hollow sphere 1002. The separation distance 1201 defines the spatial relationship between the charged elements when the mechanical energy transfer is complete.

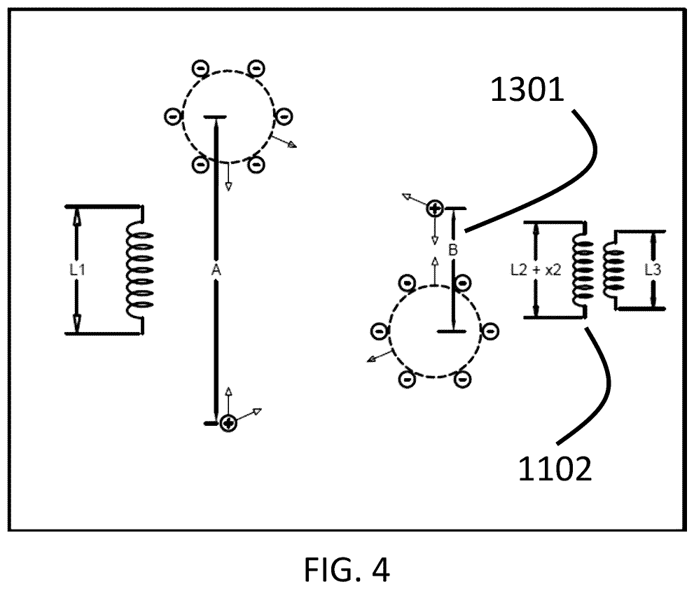

FIG. 4 depicts the mechanical system with additional spring components and inductive elements. The tension spring 1102 connects between points in the system to provide elastic energy storage during charge separation operations. A separation distance 1301 indicates the spacing achieved between the second point charge 1003 and the second hollow sphere 1004 during the energy transfer process. The system incorporates a first inductor L1, a second inductor L2, and a third inductor L3 arranged in a vertical configuration to demonstrate electromagnetic energy storage principles.

The tension spring 1102 captures electrostatic energy as the second point charge 1003 moves toward the first hollow sphere 1002 and the charge distribution of the second hollow sphere 1004 moves toward the first point charge 1001. The separation distance 1301 represents the displacement of the second point charge 1003 from the center of the second hollow sphere 1004 when the tension spring 1102 stores the transferred energy. The first inductor L1, the second inductor L2, and the third inductor L3 provide electromagnetic energy storage that complements the mechanical energy storage of the spring elements.

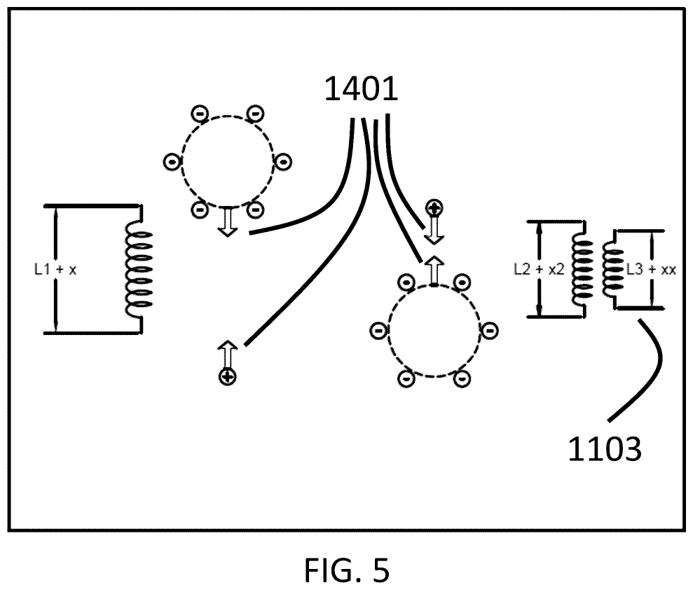

FIG. 5 illustrates the mechanical system during charge movement operations. Motion arrows 1401 indicate the direction of movement for the charged elements within the system. The relaxed spring 1103 maintains an uncompressed state while the charged elements move according to the motion arrows 1401. The motion arrows 1401 show bidirectional movement paths that enable the charged elements to return to original positions during the energy release phase of the cycle.

The motion arrows 1401 represent the movement of the first point charge 1001 and the second point charge 1003 as the charged elements return to the centers of the respective hollow spheres. The relaxed spring 1103 provides mechanical support during the movement phase without storing additional energy. The motion arrows 1401 indicate the coordinated movement of multiple charged elements as the system transitions between energy storage and energy release states.

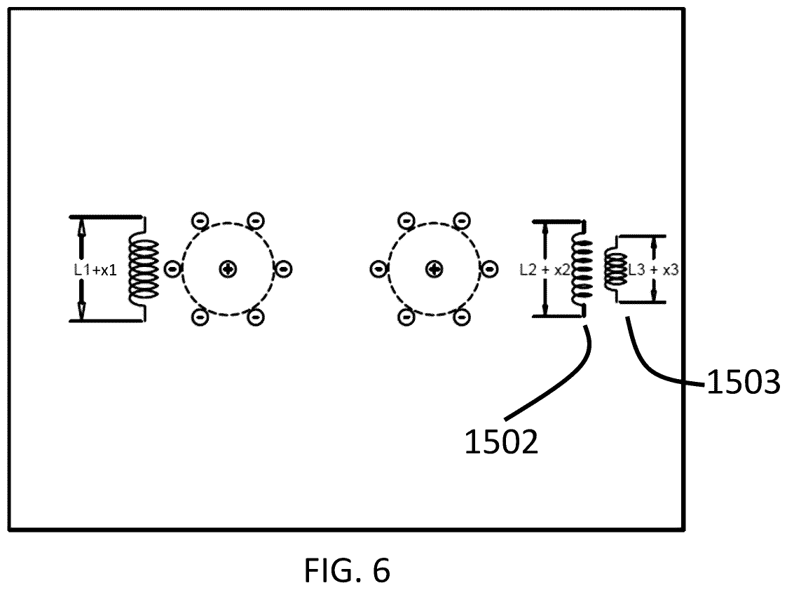

FIG. 6 shows the final configuration of the spring elements after the energy storage cycle. A tension spring 1502 maintains stored energy in a stretched configuration. A compression spring 1503 stores energy in a compressed state. The tension spring 1502 and the compression spring 1503 represent the energy storage achieved through the mechanical interactions of the charged elements during the operational cycle.

The tension spring 1502 retains the electrostatic energy captured during the charge separation process. The compression spring 1503 stores mechanical energy that can be released during subsequent operational cycles. The combination of the tension spring 1502 and the compression spring 1503 demonstrates how mechanical energy storage elements capture and retain energy from electrostatic interactions between charged components.

The mechanical energy storage components demonstrate the underlying principles that enable the capacitor system to achieve enhanced energy storage through controlled charge interactions. The compression spring 1101, the tension spring 1102, and the relaxed spring 1103 provide mechanical energy storage that complements the electrostatic energy storage of the capacitor components. The telescoping tube 1104 enables controlled positioning of charged elements to optimize energy transfer between mechanical and electrical components.

The separation distance 1201 and the separation distance 1301 define the spatial relationships that enable energy transfer from mechanical storage elements to electrostatic storage configurations. The motion arrows 1401 illustrate the coordinated movement patterns that enable the system to cycle between energy storage and energy release states. The tension spring 1502 and the compression spring 1503 retain energy from the operational cycle for subsequent use in system operation.

In some implementations, the compression spring 1101 may incorporate variable spring constants to optimize energy storage for different operational conditions. In some implementations, the tension spring 1102 may include multiple spring elements connected in series or parallel to achieve desired energy storage characteristics. In some implementations, the relaxed spring 1103 may serve as a reference element for measuring energy storage in other spring components.

In some implementations, the telescoping tube 1104 may incorporate multiple latching positions to enable variable separation distances during operation. In some implementations, the separation distance 1201 may be adjusted through mechanical controls to optimize energy transfer efficiency. In some implementations, the separation distance 1301 may be varied independently of the separation distance 1201 to achieve different energy storage configurations.

In some implementations, the first inductor L1, the second inductor L2, and the third inductor L3 may provide electromagnetic energy storage that operates in coordination with the mechanical spring elements. In some implementations, the motion arrows 1401 may represent programmable movement patterns that optimize energy transfer timing. In some implementations, the tension spring 1502 and the compression spring 1503 may incorporate materials with enhanced elastic properties for improved energy storage density.

In some implementations, the mechanical energy storage components may include damping elements to control oscillations during energy transfer operations. In some implementations, the spring elements may incorporate temperature compensation features to maintain consistent energy storage characteristics across different operating temperatures. In some implementations, the telescoping tube 1104 may include position sensing capabilities to provide feedback for precise control of charge element positioning.

In some implementations, the energy storage cycle may incorporate multiple spring elements operating in sequence to achieve staged energy transfer operations. In some implementations, the mechanical components may include safety features to prevent over-compression or over-extension of spring elements during operation. In some implementations, the system may incorporate mechanical energy recovery features that capture energy from charge movement operations for subsequent use in system operation.

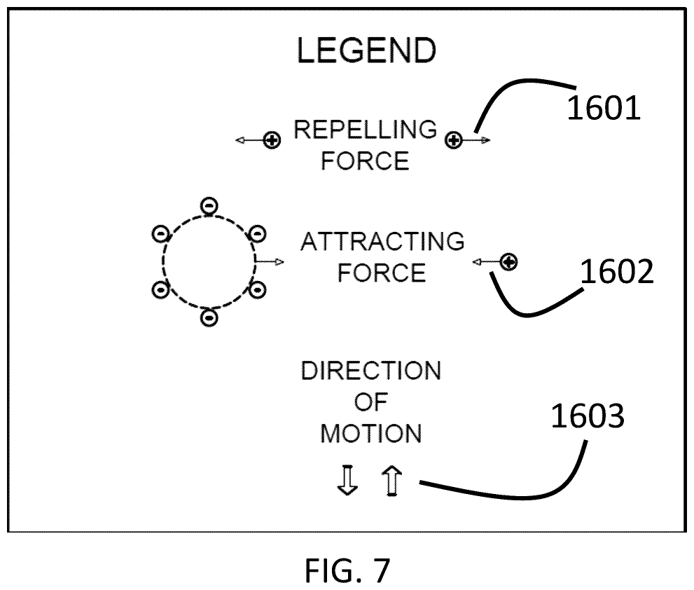

FIG. 7 shows a legend depicting different types of forces and motion indicators used in the system diagrams. The legend includes three distinct elements that represent the various forces and movements present in the system. A repelling force 1601 is shown as an arrow with a specific marking to represent forces that push elements apart. An attracting force 1602 is depicted as an arrow with a different marking to represent forces that pull elements together. A motion direction 1603 is illustrated as an arrow showing the direction of movement or motion of system components.

The repelling force 1601 indicates electromagnetic forces that cause charged elements to move away from each other when the charges have the same polarity. The repelling force 1601 appears between the first point charge 1001 and the second point charge 1003 when both charges carry positive electrical charge. The attracting force 1602 represents electromagnetic forces that cause charged elements to move toward each other when the charges have opposite polarities. The attracting force 1602 occurs between the first point charge 1001 and the second hollow sphere 1004 when the first point charge 1001 carries positive charge and the second hollow sphere 1004 carries negative charge.

The motion direction 1603 shows the actual movement paths of charged elements as the motion direction 1603 responds to the repelling force 1601 and the attracting force 1602 during system operation. The motion direction 1603 indicates how the first point charge 1001 and the second point charge 1003 move along the telescoping tube 1104 when the compression spring 1101 and the tension spring 1102 transfer energy to the charged elements. The motion direction 1603 demonstrates the coordinated movement of charged elements during the energy storage and energy release phases of the operational cycle.

The repelling force 1601 creates separation between charged elements that have the same electrical polarity. The repelling force 1601 acts along the axis of the telescoping tube 1104 to move the first point charge 1001 away from the second point charge 1003 when both charges carry positive electrical charge. The attracting force 1602 creates attraction between charged elements that have opposite electrical polarities. The attracting force 1602 acts to pull the first point charge 1001 toward the second hollow sphere 1004 when the first point charge 1001 carries positive charge and the second hollow sphere 1004 carries negative charge.

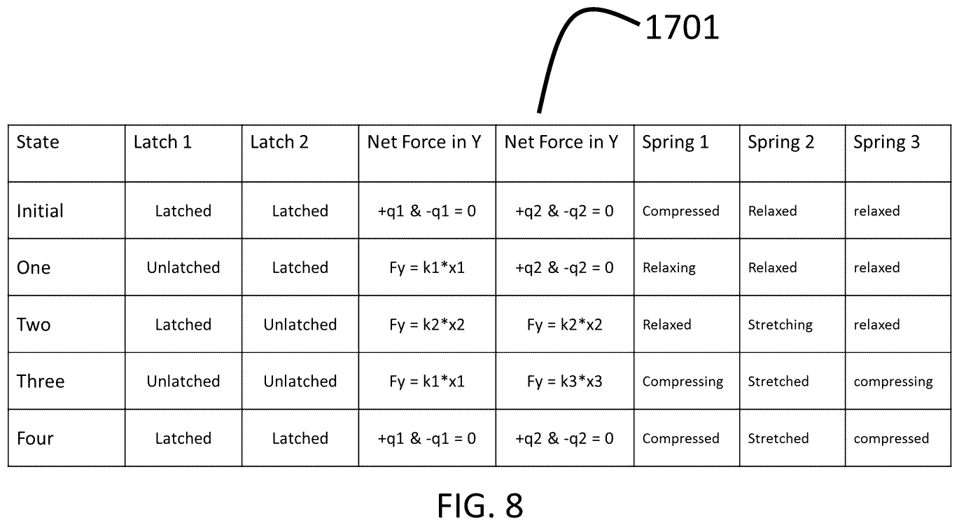

FIG. 8 shows a charge pair array 1701 that systematically documents the conditions and states of a system containing charged elements, mechanical latches, and springs across different operational phases. The charge pair array 1701 consists of multiple rows and columns that track the operational parameters throughout the system cycle. The charge pair array 1701 includes column headers that identify the tracked parameters and subsequent rows that represent different states of the system from initial configuration through multiple operational phases.

The charge pair array 1701 tracks multiple parameters across each operational state. The charge pair array 1701 documents latch conditions that indicate whether mechanical latches are engaged or disengaged during each phase. The charge pair array 1701 records force calculations that show the mathematical expressions for forces acting on the charge pairs using variables that represent different force components. The charge pair array 1701 monitors spring conditions that describe the mechanical state of each spring element as compressed, relaxed, stretching, relaxing, or stretched depending on the operational phase.

The charge pair array 1701 shows the progression through operational states with a clear pattern. The charge pair array 1701 begins with an initial state where both latches are engaged, net forces are zero, and the compression spring 1101 is compressed while other springs remain relaxed. The charge pair array 1701 progresses to a first state where the first latch releases, force equations appear, and the compression spring 1101 begins relaxing. The charge pair array 1701 continues to a second state where the second latch releases, new force equations emerge, and the tension spring 1102 begins stretching.

The charge pair array 1701 documents a third state where both latches are released, multiple force components become active, and multiple springs change states simultaneously. The charge pair array 1701 concludes with a fourth state where both latches return to engaged positions but with modified spring states compared to the initial configuration. The charge pair array 1701 demonstrates how the system energy increases through the operational cycle without external work input when net forces remain zero during specific phases.

The charge pair array 1701 records force relationships that show when the net force on charge pairs equals zero. The charge pair array 1701 indicates zero net force conditions using expressions that show balanced charge interactions. The charge pair array 1701 documents non-zero force conditions using mathematical expressions that include spring constants and displacement variables. The charge pair array 1701 tracks how force conditions change as latches engage and disengage during the operational cycle.

The charge pair array 1701 monitors spring state transitions throughout the operational cycle. The charge pair array 1701 shows how the compression spring 1101 transitions from compressed to relaxing to relaxed to compressing and back to compressed states. The charge pair array 1701 tracks how the tension spring 1102 progresses from relaxed to stretching to stretched states during the cycle. The charge pair array 1701 documents how the relaxed spring 1103 transitions from relaxed to compressing to compressed states by the end of the cycle.

The charge pair array 1701 demonstrates the energy storage principles that enable the system to achieve enhanced energy density. The charge pair array 1701 shows how mechanical energy stored in the compression spring 1101 transfers to electrostatic energy when charges separate. The charge pair array 1701 documents how electrostatic energy converts to mechanical energy stored in the tension spring 1102 and the relaxed spring 1103 during the operational cycle. The charge pair array 1701 illustrates how the system returns to the initial charge configuration but with additional energy stored in multiple spring elements.

The force interactions documented in the charge pair array 1701 enable controlled energy transfer between mechanical and electrostatic storage elements. The repelling force 1601 and the attracting force 1602 create the electromagnetic interactions that drive charge movement along the motion direction 1603. The charge pair array 1701 tracks how these force interactions coordinate with latch operations to achieve energy transfer without external work input during phases when net forces equal zero.

In some implementations, the repelling force 1601 may incorporate multiple charge interactions that create complex force patterns for enhanced energy transfer efficiency. In some implementations, the attracting force 1602 may include variable force magnitudes that change based on charge separation distances during operation. In some implementations, the motion direction 1603 may represent programmable movement patterns that optimize energy transfer timing between mechanical and electrostatic components.

In some implementations, the charge pair array 1701 may include additional operational states that extend the energy storage cycle for enhanced energy accumulation. In some implementations, the charge pair array 1701 may track additional parameters such as temperature, pressure, or electromagnetic field strength during operation. In some implementations, the charge pair array 1701 may incorporate real-time monitoring capabilities that adjust operational parameters based on measured system performance.

In some implementations, the force relationships may include non-linear components that enhance energy transfer efficiency under specific operational conditions. In some implementations, the spring state transitions may incorporate multiple spring elements operating in parallel to increase energy storage capacity. In some implementations, the latch operations may include variable timing controls that optimize energy transfer between different operational phases.

In some implementations, the energy storage principles may incorporate multiple charge pair arrays operating in coordination to achieve scaled energy storage capabilities. In some implementations, the force interactions may include electromagnetic coupling between adjacent charge pairs to enhance overall system energy density. In some implementations, the operational cycle may incorporate feedback control that adjusts force interactions based on measured energy storage efficiency.

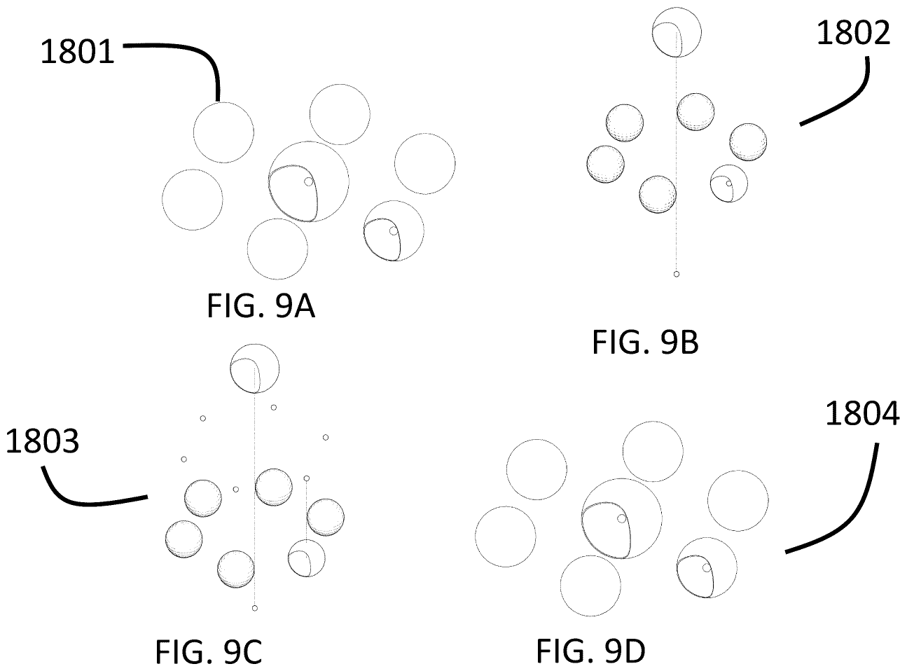

FIGS. 9A-9D illustrate an expanded charge arrangement system that scales up the basic charge interaction principles through radial configurations. The figures show a central charge pair 1802 positioned at the center, surrounded by a charge pair set 1801 arranged in a circular pattern around the central charge pair 1802. The charge pair set 1801 comprises six individual charge pairs distributed radially around the central charge pair 1802. A separated charge pair 1803 demonstrates the displacement of charges from their original positions during operational cycles. A charge pair distance 1804 indicates the spatial separation between the charge elements in the expanded system.

The central charge pair 1802 operates according to the same principles as the first point charge 1001 and the first hollow sphere 1002 described previously. The central charge pair 1802 includes a point charge positioned at the center of a hollow sphere with uniformly distributed charge across the spherical surface. The charge pair set 1801 surrounds the central charge pair 1802 in a radial arrangement where each individual charge pair within the charge pair set 1801 maintains the same structural configuration as the second point charge 1003 and the second hollow sphere 1004.

FIGS. 9A-9D follow the expanded system through four operational states that correspond to the energy storage cycle. FIG. 9A shows the initial state where all charge pairs within the charge pair set 1801 are positioned at the centers of their respective hollow spheres along with the central charge pair 1802. FIG. 9B illustrates the first state where the central charge pair 1802 separates while the charge pair set 1801 remains in the initial configuration. FIG. 9C depicts the second state where the charge pair set 1801 separates to form the separated charge pair 1803 configuration while maintaining the charge pair distance 1804 between elements. FIG. 9D shows the final state where all charge pairs return to their original positions.

The separated charge pair 1803 configuration demonstrates how multiple charge pairs can be displaced simultaneously from their initial positions. The separated charge pair 1803 arrangement enables energy storage in multiple spring elements connected to each charge pair within the charge pair set 1801. The charge pair distance 1804 defines the spatial relationships between the separated charge elements and determines the electrostatic energy storage achieved during the operational cycle.

The radial arrangement of the charge pair set 1801 around the central charge pair 1802 enables coordinated energy storage operations across multiple charge pairs simultaneously. The charge pair set 1801 responds to the electric field changes created by the separation of the central charge pair 1802. The separated charge pair 1803 configuration stores electrostatic energy in six individual spring elements corresponding to each charge pair within the charge pair set 1801. The charge pair distance 1804 remains consistent across all charge pairs within the charge pair set 1801 to maintain uniform energy storage characteristics.

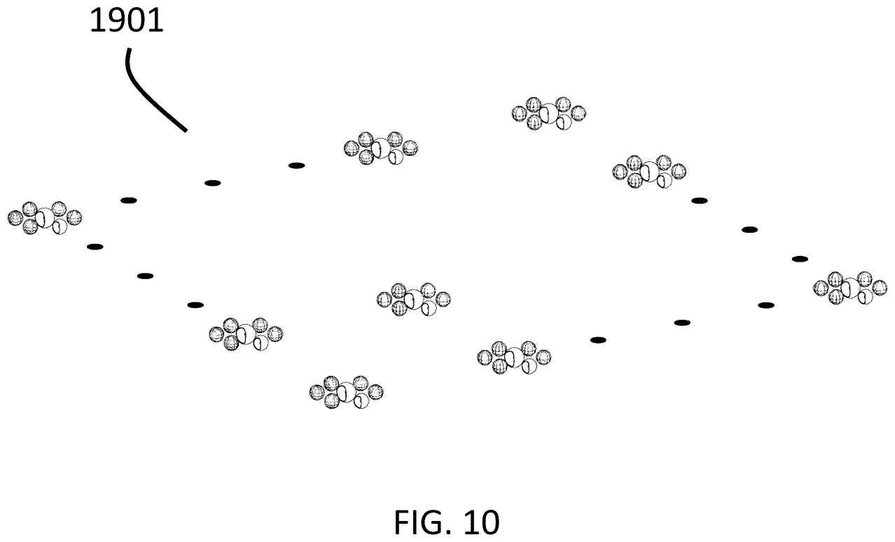

FIG. 10 shows a planar charge array 1901 that extends the radial configuration concept across a two-dimensional surface. The planar charge array 1901 comprises multiple sets of charge pairs distributed across a planar surface in a repeating pattern. Each set within the planar charge array 1901 contains a central charge pair surrounded by additional charge pairs positioned radially around the central charge pair, similar to the arrangement shown in FIGS. 9A-9D. The planar charge array 1901 demonstrates how the basic charge interaction principles can be scaled to larger arrays for increased energy storage capacity.

The planar charge array 1901 arranges the charge pair sets in a systematic grid pattern across the two-dimensional surface. The planar charge array 1901 maintains uniform spacing between adjacent charge pair sets to enable coordinated operation across the entire array. The planar charge array 1901 enables simultaneous operation of multiple radial charge configurations to achieve scaled energy storage capabilities beyond single charge pair arrangements.

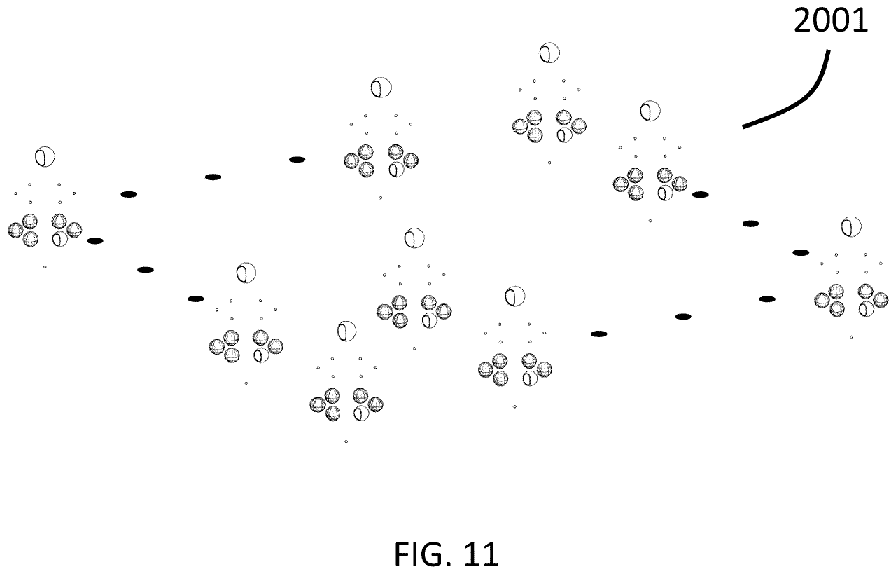

FIG. 11 illustrates a separated charge array 2001 that shows the three-dimensional implementation of the expanded charge configuration. The separated charge array 2001 displays multiple sets of charge pairs that have been separated from their initial positions, creating an organized three-dimensional configuration with four distinct planar layers. The separated charge array 2001 demonstrates how the planar charge array 1901 concept extends into three-dimensional space for enhanced energy storage density.

The separated charge array 2001 arranges the separated charge elements in parallel planes with each plane containing multiple charge pairs distributed in a regular pattern. The separated charge array 2001 maintains uniform spacing between the planes to create consistent separation distances between the charged layers. The separated charge array 2001 shows charge elements represented as individual points with circular outlines indicating their associated hollow spheres arranged in a systematic grid pattern across each plane.

The separated charge array 2001 enables systematic charging and discharging cycles across multiple planar layers simultaneously. The separated charge array 2001 creates the foundation for the capacitive energy storage system by positioning the separated charge elements to maximize interaction between layers while maintaining electrical isolation. The separated charge array 2001 demonstrates how the four parallel planes correspond to the conductive surfaces that form the outer capacitor plates 2201 and the inner capacitor plates 2202 in the embedded capacitor configuration.

The regular geometric arrangement of charge elements within the separated charge array 2001 creates a repeating pattern that can be extended to create larger arrays for different power requirements. The separated charge array 2001 maintains consistent spacing and alignment between planes to enable proper operation of the embedded capacitor system. The separated charge array 2001 provides the theoretical foundation for converting the conceptual charge interaction system into the practical capacitor implementation described in subsequent figures.

In some implementations, the charge pair set 1801 may include different numbers of charge pairs arranged around the central charge pair 1802 to optimize energy storage for specific applications. In some implementations, the central charge pair 1802 may incorporate variable charge magnitudes to control the interaction strength with the surrounding charge pair set 1801. In some implementations, the separated charge pair 1803 configuration may include adjustable separation distances to optimize energy storage density.

In some implementations, the charge pair distance 1804 may be varied independently for different charge pairs within the charge pair set 1801 to create non-uniform energy storage distributions. In some implementations, the planar charge array 1901 may incorporate different charge pair densities across the two-dimensional surface to achieve gradient energy storage characteristics. In some implementations, the planar charge array 1901 may include multiple layers of charge pair sets to create three-dimensional energy storage configurations.

In some implementations, the separated charge array 2001 may incorporate additional planar layers beyond the four layers shown to increase energy storage capacity. In some implementations, the separated charge array 2001 may include variable spacing between planes to optimize electric field interactions between layers. In some implementations, the separated charge array 2001 may incorporate different charge densities on different planes to create asymmetric field configurations for enhanced energy transfer efficiency.

In some implementations, the radial arrangements may include charge pairs positioned at different radial distances from the central charge pair 1802 to create multi-ring configurations. In some implementations, the charge pair sets may incorporate different charge polarities to create complex field patterns that enhance energy storage capabilities. In some implementations, the planar arrangements may include hexagonal or other geometric patterns that optimize charge pair spacing for maximum energy density.

In some implementations, the three-dimensional configurations may incorporate cylindrical or spherical arrangements of charge pairs to create omnidirectional energy storage systems. In some implementations, the separated charge configurations may include dynamic positioning systems that adjust charge pair locations during operation to optimize energy transfer efficiency. In some implementations, the expanded charge arrangements may incorporate feedback control systems that monitor charge interactions and adjust configurations based on measured performance parameters.

FIG. 14 shows the complete operational cycle through sequential charging and discharging steps that enable continuous energy output from the capacitor system. The operational cycle progresses through nine distinct states that coordinate the charging and discharging of the outer capacitor plates 2201 and the inner capacitor plates 2202. The sequential operation maintains controlled timing relationships between the power source 2207, the electrical load 2206, and the control switches to achieve continuous energy delivery.

The operational cycle begins with an initial state step 2301 that represents the starting condition where all control switches remain open and no charges exist on either the outer capacitor plates 2201 or the inner capacitor plates 2202. The initial state step 2301 establishes the baseline condition before energy storage operations commence. The system remains in the initial state step 2301 until the control circuit activates the first charging sequence.

The cycle progresses to an outer capacitor charging step 2302 when the outer charging switch S1 closes to enable current flow from the power source 2207 to the outer capacitor plates 2201. The outer capacitor charging step 2302 transfers electrical energy from the power source 2207 to the outer capacitor plates 2201 through the closed outer charging switch S1. The outer capacitor charging step 2302 continues until the outer capacitor plates 2201 reach full charge capacity.

The system transitions to an outer capacitor charged step 2303 when the outer capacitor plates 2201 complete the charging process and the outer charging switch S1 opens. The outer capacitor charged step 2303 represents the state where the outer capacitor plates 2201 maintain full charge while the outer charging switch S1 prevents further current flow from the power source 2207. The outer capacitor charged step 2303 establishes the electric field environment between the outer capacitor plates 2201 that enables charging of the inner capacitor plates 2202.

The operational cycle advances to an inner capacitor charging step 2304 when the inner capacitor switch S3 closes to allow current flow between the inner capacitor plates 2202 and the electrical load 2206. The inner capacitor charging step 2304 utilizes the electric field generated by the outer capacitor plates 2201 to drive current through the inner capacitor plates 2202. The inner capacitor charging step 2304 transfers energy from the electric field environment to the inner capacitor plates 2202 while delivering current through the electrical load 2206.

The system reaches an inner capacitor charged step 2305 when the inner capacitor plates 2202 achieve full charge and the inner capacitor switch S3 opens. The inner capacitor charged step 2305 represents the state where both the outer capacitor plates 2201 and the inner capacitor plates 2202 maintain full charge simultaneously. The inner capacitor charged step 2305 stores maximum energy in both capacitor components before the discharge sequence begins.

The cycle continues to an outer capacitor discharging step 2306 when the outer discharge switch S2 closes to provide a discharge path for the outer capacitor plates 2201. The outer capacitor discharging step 2306 allows the outer capacitor plates 2201 to discharge through the shorting pathway created by the closed outer discharge switch S2. The outer capacitor discharging step 2306 collapses the electric field between the outer capacitor plates 2201 while maintaining charge on the inner capacitor plates 2202.

The system transitions to an outer capacitor discharged step 2307 when the outer capacitor plates 2201 complete the discharge process and the outer discharge switch S2 opens. The outer capacitor discharged step 2307 represents the state where the outer capacitor plates 2201 carry no charge while the inner capacitor plates 2202 maintain full charge. The outer capacitor discharged step 2307 eliminates the external electric field that previously supported the charge on the inner capacitor plates 2202.

The operational cycle advances to an inner capacitor discharging step 2308 when the inner capacitor switch S3 closes to enable discharge of the inner capacitor plates 2202 through the electrical load 2206. The inner capacitor discharging step 2308 allows current to flow from the inner capacitor plates 2202 through the electrical load 2206 in the opposite direction from the inner capacitor charging step 2304. The inner capacitor discharging step 2308 delivers the stored energy from the inner capacitor plates 2202 to the electrical load 2206.

The cycle concludes with an inner capacitor discharged step 2309 when the inner capacitor plates 2202 complete the discharge process and the inner capacitor switch S3 opens. The inner capacitor discharged step 2309 returns the system to a state where both the outer capacitor plates 2201 and the inner capacitor plates 2202 carry no charge. The inner capacitor discharged step 2309 completes one full operational cycle and enables the system to begin the next cycle by returning to the outer capacitor charging step 2302.

FIG. 15 illustrates the voltage and current characteristics during the operational cycle through the charging voltage plot 2401, the discharging voltage plot 2402, and the current plot 2403. The charging voltage plot 2401 shows the voltage increase across the capacitor plates during the charging phases of the operational cycle. The discharging voltage plot 2402 demonstrates the voltage decrease across the capacitor plates during the discharge phases. The current plot 2403 displays how current flow varies throughout both charging and discharging phases of the complete operational cycle.

The charging voltage plot 2401 depicts the exponential voltage rise that occurs during the outer capacitor charging step 2302 and the inner capacitor charging step 2304. The charging voltage plot 2401 shows the characteristic capacitor charging curve where voltage increases rapidly initially and approaches the final voltage asymptotically. The discharging voltage plot 2402 illustrates the exponential voltage decay that occurs during the outer capacitor discharging step 2306 and the inner capacitor discharging step 2308. The discharging voltage plot 2402 demonstrates the characteristic capacitor discharge curve where voltage decreases rapidly initially and approaches zero asymptotically.

The current plot 2403 shows the current flow patterns that correspond to the voltage changes during charging and discharging operations. The current plot 2403 indicates high initial current flow during the beginning of charging phases that decreases as the capacitor plates approach full charge. The current plot 2403 also shows high initial current flow during the beginning of discharge phases that decreases as the capacitor plates approach complete discharge. The current plot 2403 demonstrates how current flow through the electrical load 2206 varies throughout the operational cycle.

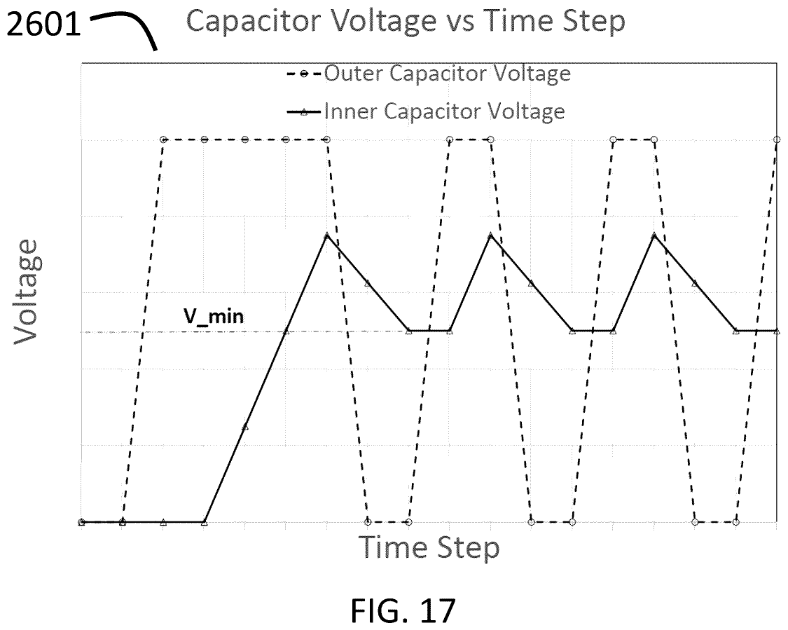

FIG. 17 shows an outer capacitor voltage 2601 plotted against time to illustrate the voltage behavior during continuous operational cycles. The outer capacitor voltage 2601 follows a repeating sawtooth waveform pattern with distinct rising and falling edges that correspond to the charging and discharging states of the outer capacitor plates 2201. The outer capacitor voltage 2601 demonstrates how the voltage across the outer capacitor plates 2201 cycles between zero and maximum voltage levels throughout continuous operation.

The outer capacitor voltage 2601 rises during the outer capacitor charging step 2302 when the outer charging switch S1 enables current flow from the power source 2207. The outer capacitor voltage 2601 remains at maximum level during the outer capacitor charged step 2303 and the inner capacitor charging step 2304 while the outer charging switch S1 stays open. The outer capacitor voltage 2601 decreases rapidly during the outer capacitor discharging step 2306 when the outer discharge switch S2 provides the discharge pathway. The outer capacitor voltage 2601 remains at zero during the outer capacitor discharged step 2307 and the inner capacitor discharging step 2308.

The timing relationships between the operational steps enable continuous energy output while maintaining controlled voltage levels across both capacitor components. The outer capacitor charging step 2302 occurs before the inner capacitor charging step 2304 to establish the electric field environment needed for inner capacitor charging. The inner capacitor charged step 2305 overlaps with the beginning of the outer capacitor discharging step 2306 to maintain energy storage in the inner capacitor plates 2202 while the outer capacitor plates 2201 discharge. The inner capacitor discharging step 2308 delivers energy to the electrical load 2206 after the outer capacitor discharged step 2307 eliminates the external electric field.

The state transitions coordinate the switching operations to maintain continuous current flow through the electrical load 2206 during both charging and discharging phases. The transition from the outer capacitor charged step 2303 to the inner capacitor charging step 2304 enables energy transfer from the electric field to the inner capacitor plates 2202. The transition from the inner capacitor charged step 2305 to the outer capacitor discharging step 2306 prepares the system for inner capacitor discharge. The transition from the outer capacitor discharged step 2307 to the inner capacitor discharging step 2308 delivers stored energy from the inner capacitor plates 2202 to the electrical load 2206.

The sequential timing maintains energy delivery to the electrical load 2206 throughout the complete operational cycle. The inner capacitor charging step 2304 provides current flow through the electrical load 2206 in one direction while the inner capacitor plates 2202 charge using the electric field from the outer capacitor plates 2201. The inner capacitor discharging step 2308 provides current flow through the electrical load 2206 in the opposite direction while the inner capacitor plates 2202 discharge the stored energy. The bidirectional current flow through the electrical load 2206 enables continuous energy delivery despite the alternating charging and discharging operations.

In some implementations, the timing of the outer capacitor charging step 2302 can be adjusted to optimize the charging rate of the outer capacitor plates 2201 based on the capacitance and resistance characteristics of the system. In some implementations, the duration of the outer capacitor charged step 2303 can be varied to control the electric field strength available for charging the inner capacitor plates 2202. In some implementations, the timing of the inner capacitor charging step 2304 can be modified to optimize energy transfer efficiency from the electric field to the inner capacitor plates 2202.

In some implementations, the outer capacitor discharging step 2306 can incorporate controlled discharge rates through variable resistance pathways to manage the rate of electric field collapse. In some implementations, the inner capacitor discharging step 2308 can include adjustable discharge timing to optimize energy delivery characteristics to different types of electrical loads. In some implementations, the state transitions can incorporate overlap periods where multiple switches remain closed simultaneously to provide smoother current transitions.

In some implementations, the operational cycle can include additional intermediate steps that provide finer control over the charging and discharging processes. In some implementations, the voltage monitoring during each step can provide feedback control that adjusts the timing of subsequent steps based on measured voltage levels. In some implementations, the current flow patterns can be modified through variable load resistance to optimize energy transfer efficiency during different phases of the operational cycle.

In some implementations, the sawtooth waveform pattern of the outer capacitor voltage 2601 can be modified through different charging and discharging profiles to achieve specific voltage characteristics. In some implementations, the timing relationships can be adjusted dynamically during operation to compensate for component aging or changing load conditions. In some implementations, the sequential operation can incorporate multiple parallel cycles operating with phase offsets to provide smoother overall current delivery to the electrical load 2206.

FIG. 25 illustrates a control flow chart 3400 that documents the programming logic for managing the charging and discharging cycles of the capacitor system. The control flow chart 3400 shows the method 3401 that coordinates the sequential operation of the outer charging switch S1, the outer discharge switch S2, and the inner capacitor switch S3 throughout the operational cycles. The method 3401 incorporates monitoring capabilities that track system health parameters and provide user feedback through the display panel 3303.

The control flow chart 3400 begins with a startup sequence that initializes the capacitor system before normal cycling operation. The method 3401 checks for a signal from an ON switch to determine when to begin the startup loop. When the ON switch signal reads HIGH, the method 3401 initiates the startup sequence by sending a HIGH signal to the control pin E 2701 that activates the NMOS field effect transistor for outer capacitor charging. The method 3401 implements a delay period of five times the RC time constant to allow complete charging of the outer capacitor plates 2201 before proceeding to the next step.

The startup sequence continues when the method 3401 sends a LOW signal to the control pin E 2701 to deactivate outer capacitor charging and then sends a HIGH signal to the control pin J 2702 to begin inner capacitor charging through the limiting resistor 2703. The method 3401 increments a cycle counter to track the number of operational cycles and saves timing information to a delta_t variable for performance monitoring. The method 3401 monitors the voltage reading at the circuit point A 2704 and compares the voltage to a minimum voltage threshold V_min. When the voltage reading exceeds V_min, the method 3401 sends a LOW signal to the control pin J 2702 to complete the startup loop and transition to normal cycling operation.

The control flow chart 3400 shows the operating loop that manages continuous charging and discharging cycles after startup completion. The method 3401 begins each operating cycle by sending a HIGH signal to the control pin G1 2705 and the control pin G2 2706 to enable inner capacitor charging through the electrical load 2707 and the smoothing capacitor 2708. The method 3401 increments the cycle counter to maintain an accurate count of completed cycles and updates the display panel 3303 with current operational information. The method 3401 saves the start time to monitor charging duration and detect performance changes over operational cycles.

The method 3401 monitors the voltage between the circuit point A 2704 and the control pin B 2713 during inner capacitor charging operations. When the voltage reading reaches a maximum voltage threshold V_max, the method 3401 sends a LOW signal to the control pin G1 2705 and the control pin G2 2706 to stop inner capacitor charging. The method 3401 saves the end time and calculates the delta_t value by subtracting the start time from the end time to determine the charging duration for the current cycle.

The control flow chart 3400 includes performance monitoring logic that tracks charging time changes to assess system health. For the first cycle, the method 3401 sets an initial_delta_t value equal to the measured delta_t to establish a baseline charging time reference. For subsequent cycles, the method 3401 calculates a percent change value every 100 cycles by dividing the current delta_t by the initial_delta_t to monitor performance degradation. The method 3401 updates the display panel 3303 with the percent change value to provide user feedback about system health. When the percent change falls below 0.8, the method 3401 activates a yellow warning light to indicate approaching maintenance requirements.

The operating loop continues with outer capacitor discharge operations when the method 3401 sends a HIGH signal to a control pin F to activate the discharge resistor 2710 pathway. The method 3401 implements a delay period of five times the RC time constant to allow complete discharge of the outer capacitor plates 2201 through the discharge resistor 2710. The method 3401 then sends a LOW signal to the control pin F to stop outer capacitor discharge and prepares for inner capacitor discharge operations.

The method 3401 manages inner capacitor discharge by sending a HIGH signal to the control pin H1 2711 and the control pin H2 2712 to enable current flow from the inner capacitor plates 2202 through the electrical load 2707 in the opposite direction from the charging phase. The method 3401 monitors the voltage reading at the circuit point A 2704 during discharge operations. When the voltage reading falls below V_min, the method 3401 sends a LOW signal to the control pin H1 2711 and the control pin H2 2712 to stop inner capacitor discharge.

The control flow chart 3400 completes each operating cycle when the method 3401 initiates the next outer capacitor charging sequence. The method 3401 sends a HIGH signal to the control pin E 2701 to begin charging the outer capacitor plates 2201 for the subsequent cycle. The method 3401 implements the delay period for outer capacitor charging and then sends a LOW signal to the control pin E 2701 before returning to the beginning of the operating loop for continuous cycle repetition.

The method 3401 coordinates the timing relationships between control pin activations to maintain proper sequencing of charging and discharging operations. The method 3401 ensures that the outer capacitor plates 2201 complete charging before the inner capacitor plates 2202 begin charging to establish the electric field environment needed for inner capacitor operation. The method 3401 coordinates the discharge timing to maintain current flow through the electrical load 2707 during both charging and discharging phases of the operational cycle.

The control flow chart 3400 incorporates voltage monitoring capabilities that maintain system operation within specified voltage ranges. The method 3401 compares measured voltages to the V_min and V_max thresholds to determine when to transition between operational states. The voltage monitoring prevents overvoltage conditions that could damage the capacitor components and prevents undervoltage conditions that could reduce energy delivery efficiency.

The method 3401 includes cycle counting functionality that tracks the total number of completed operational cycles throughout the system lifetime. The cycle counter increments each time the capacitor system completes a full charging and discharging sequence. The method 3401 transmits the cycle count information to the display panel 3303 to provide users with operational history data for maintenance planning and performance assessment.

The control flow chart 3400 shows timing control features that coordinate the sequential activation of field effect transistors connected to each control pin. The method 3401 manages the timing delays based on circuit time constants to ensure complete charging and discharging of capacitor components before transitioning between operational states. The timing control maintains synchronization across multiple operational phases to achieve continuous energy delivery through the electrical load 2707.

In some implementations, the method 3401 may incorporate additional voltage monitoring points beyond the circuit point A 2704 and the control pin B 2713 to provide more comprehensive system monitoring. In some implementations, the control flow chart 3400 may include temperature monitoring capabilities that adjust operational parameters based on measured thermal conditions. In some implementations, the method 3401 may incorporate adaptive timing algorithms that modify delay periods based on measured charging and discharging characteristics.

In some implementations, the cycle counting functionality may include separate counters for different types of operational cycles to provide more detailed performance tracking. In some implementations, the performance monitoring logic may track additional parameters such as current flow levels, power output, and energy efficiency throughout operational cycles. In some implementations, the warning system may include multiple threshold levels that provide graduated alerts as system performance approaches operational limits.

In some implementations, the method 3401 may incorporate communication interfaces that transmit operational data to external monitoring systems for remote system management. In some implementations, the control flow chart 3400 may include diagnostic modes that provide detailed operational information for troubleshooting and maintenance procedures. In some implementations, the method 3401 may include user-configurable parameters that allow adjustment of voltage thresholds, timing delays, and warning levels based on specific application requirements.

In some implementations, the startup sequence may include additional initialization steps that verify proper operation of all control pins and monitoring circuits before beginning normal cycling operation. In some implementations, the operating loop may incorporate fault detection capabilities that identify malfunctioning components and implement protective measures to prevent system damage. In some implementations, the method 3401 may include power management features that optimize energy consumption during different operational modes.

In some implementations, the control flow chart 3400 may incorporate multiple operating modes that provide different charging and discharging profiles for various load conditions. In some implementations, the method 3401 may include data logging capabilities that store historical operational information for long-term performance analysis. In some implementations, the timing control may incorporate feedback mechanisms that adjust operational timing based on measured system response characteristics.

In some implementations, the voltage monitoring may include programmable gain amplifiers that accommodate different voltage ranges during operation. In some implementations, the method 3401 may incorporate safety interlocks that prevent operation under unsafe conditions such as overtemperature or overcurrent situations. In some implementations, the control flow chart 3400 may include calibration procedures that maintain measurement accuracy throughout the operational lifetime of the capacitor system.

FIG. 13 shows the system integration where the outer capacitor plates 2201 and the inner capacitor plates 2202 operate together through coordinated control switching to achieve continuous energy storage and delivery. The outer capacitor plates 2201 connect to the power source 2207 through the first control switch 2203 that functions as the outer charging switch S1. The inner capacitor plates 2202 connect to the electrical load 2206 through the third control switch 2205 that operates as the inner capacitor switch S3. The second control switch 2204 provides discharge control for the outer capacitor plates 2201 as the outer discharge switch S2.

The system integration enables the outer capacitor plates 2201 to generate an electric field environment that charges the inner capacitor plates 2202 without direct electrical connection between the capacitor components. The outer capacitor plates 2201 store electrical energy from the power source 2207 when the outer charging switch S1 closes. The electric field created between the outer capacitor plates 2201 provides the energy source for charging the inner capacitor plates 2202 when the inner capacitor switch S3 enables current flow through the electrical load 2206.

The control circuit coordinates the switching sequence to maintain continuous power delivery through the electrical load 2206. The outer charging switch S1 activates first to charge the outer capacitor plates 2201 using energy from the power source 2207. The inner capacitor switch S3 then enables the inner capacitor plates 2202 to charge using the electric field from the outer capacitor plates 2201 while delivering current through the electrical load 2206. The outer discharge switch S2 subsequently discharges the outer capacitor plates 2201 to collapse the external electric field. The inner capacitor switch S3 then enables the inner capacitor plates 2202 to discharge through the electrical load 2206 in the opposite current direction.

FIG. 18 illustrates the circuit assembly 2700 that integrates multiple capacitor components with comprehensive control and monitoring systems. The circuit assembly 2700 incorporates the control pin E 2701 that manages outer capacitor charging operations through NMOS field effect transistors. The control pin J 2702 coordinates inner capacitor charging through PMOS field effect transistors connected to the limiting resistor 2703. The circuit point A 2704 provides voltage sensing capabilities that monitor charging progress during operational cycles.

The circuit assembly 2700 includes the control pin G1 2705 and the control pin G2 2706 that direct inner capacitor charging current through rectifying circuit arms to the electrical load 2707. The smoothing capacitor 2708 operates in parallel with the electrical load 2707 to maintain stable voltage delivery during switching transitions. The control pin H1 2711 and the control pin H2 2712 manage inner capacitor discharge current flow through opposite rectifying circuit arms while maintaining consistent current direction through the electrical load 2707.

The integrated control system coordinates current flow through multiple circuit paths depending on control pin activation states. The limiting resistor 2703 regulates current levels during initial charging operations to prevent component damage. The discharge resistor 2710 provides controlled discharge pathways for the outer capacitor plates when activated through switching circuitry. The control pin B 2713 enables additional voltage sensing and control functions within the circuit assembly 2700.

The rectifying circuit configuration maintains unidirectional current flow through the electrical load 2707 while enabling bidirectional current flow through the inner capacitor plates during charging and discharging cycles. The control pin G1 2705 and the control pin G2 2706 activate during inner capacitor charging to direct current through one set of rectifying circuit arms. The control pin H1 2711 and the control pin H2 2712 activate during inner capacitor discharge to direct current through the opposite rectifying circuit arms. The rectifying bridge circuit coordinates with the smoothing capacitor 2708 to provide stable DC power delivery throughout the operational cycles.

FIG. 24 shows the mechanical assembly 3301 that integrates all system components within the housing body 3307 to provide complete energy storage and delivery functionality. The mechanical assembly 3301 contains multiple capacitor stacks 3305 arranged within the housing body 3307 in configurations that enable series and parallel connections for scalable voltage and current output. The control board 3304 manages the charging and discharging operations of the capacitor stacks 3305 through electronic circuitry that coordinates timing and sequencing throughout system cycles.

The power supply 3306 connects to the outer capacitor components within each of the capacitor stacks 3305 to provide charging energy for outer capacitor operations. The control board 3304 incorporates switching circuitry that manages the timing of charging and discharging cycles for each capacitor stack 3305 within the array. The microprocessor 3201 on the control board 3304 monitors voltage levels across individual capacitor stacks 3305 and across combined series-parallel arrangements to maintain operation within specified voltage ranges.

The display panel 3303 integrated into the enclosure lid 3302 provides real-time operational feedback that shows voltage levels, charging status, and cycle counts for the capacitor stacks 3305. The display panel 3303 receives control signals from the control board 3304 to update displayed information based on operational measurements from the microprocessor 3201. The enclosure lid 3302 secures the internal components while providing user access to the display panel 3303 for system monitoring.

The integrated system achieves enhanced energy density through coordinated operation of multiple capacitor stacks 3305 arranged in series and parallel configurations. The series arrangement of capacitor stacks 3305 increases total voltage output beyond individual stack limitations while the parallel arrangement increases total current capacity. The control board 3304 synchronizes the charging and discharging operations across all capacitor stacks 3305 to maintain coordinated energy delivery through connected electrical loads.

The system integration enables continuous power output through sequential charging and discharging cycles that maintain current flow during both operational phases. The outer capacitor components within the capacitor stacks 3305 charge first to establish electric field environments for inner capacitor charging. The inner capacitor components then charge using the electric field energy while delivering current to electrical loads. The outer capacitor components subsequently discharge to collapse external electric fields, followed by inner capacitor discharge that delivers stored energy to electrical loads in the opposite current direction.

The monitoring systems within the mechanical assembly 3301 track operational parameters including cycle counts, voltage levels, and performance metrics throughout system operation. The microprocessor 3201 counts completed charging and discharging cycles and calculates charging time measurements to detect performance changes over operational cycles. The display panel 3303 presents operational information and activates warning indicators when cycle counts or performance parameters approach predetermined thresholds.

In some implementations, the system integration may incorporate additional voltage monitoring points beyond the circuit point A 2704 and the control pin B 2713 to provide comprehensive system monitoring across multiple capacitor stacks 3305. In some implementations, the control board 3304 may include individual monitoring circuits for each capacitor stack 3305 to track performance and cycle life of individual stacks within the array. In some implementations, the mechanical assembly 3301 may incorporate thermal management systems that distribute heat dissipation across multiple capacitor stacks 3305 to maintain uniform operating temperatures.

In some implementations, the circuit assembly 2700 may include additional protection features such as overcurrent detection and thermal monitoring to prevent damage during operation. In some implementations, the rectifying circuit configuration may incorporate synchronous switching elements rather than diode rectification to improve energy transfer efficiency. In some implementations, the smoothing capacitor 2708 may comprise multiple capacitors connected in parallel to achieve desired capacitance values and current handling capabilities.

In some implementations, the power supply 3306 may include voltage regulation circuitry to maintain consistent charging voltage across all capacitor stacks 3305 in parallel arrangements. In some implementations, the display panel 3303 may incorporate touchscreen functionality to enable user input for system configuration and control parameters. In some implementations, the housing body 3307 may include ventilation features or cooling systems to manage thermal output during high-current operation.

In some implementations, the system integration may incorporate wireless communication interfaces for transmitting operational data to external monitoring systems. In some implementations, the control board 3304 may include fault detection circuitry that identifies malfunctioning capacitor stacks 3305 and isolates malfunctioning stacks from the array while maintaining operation of functional stacks. In some implementations, the mechanical assembly 3301 may include bypass switching that enables continued operation with reduced capacity when individual capacitor stacks 3305 undergo maintenance or replacement.

In some implementations, the integrated control system may incorporate adaptive timing algorithms that adjust charging and discharging periods based on measured system performance. In some implementations, the monitoring systems may include data logging capabilities that store historical operational information for long-term performance analysis. In some implementations, the system integration may incorporate multiple operating modes that provide different charging and discharging profiles for various load conditions.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A capacitor system, comprising:
an outer capacitor;
an inner capacitor embedded within the outer capacitor;
a power source connected to the outer capacitor; and
a control circuit configured to:
charge the outer capacitor using the power source,
charge the inner capacitor across an external load using an electric field generated by the outer capacitor, and
discharge the inner capacitor across the external electrical load.

2. The capacitor system of claim 1, wherein the outer capacitor comprises a pair of conductive plates separated by a dielectric material.

3. The capacitor system of claim 2, wherein the conductive plates of the outer capacitor are made of a material selected from the group consisting of aluminum, copper, and stainless steel.

4. The capacitor system of claim 1, wherein the inner capacitor comprises a pair of conductive plates coated with activated carbon or graphene.

5. The capacitor system of claim 4, further comprising an electrolyte membrane positioned between the conductive plates of the inner capacitor.

6. The capacitor system of claim 1, wherein the control circuit comprises a microprocessor configured to control charging and discharging cycles of the outer and inner capacitors.

7. The capacitor system of claim 6, wherein the microprocessor is programmed to maintain the voltage of the inner capacitor within a specified range.

8. The capacitor system of claim 1, further comprising a plurality of capacitor stacks, each stack comprising an outer capacitor and an inner capacitor.

9. The capacitor system of claim 8, wherein the plurality of capacitor stacks are arranged in a series configuration, a parallel configuration, or a combination thereof.

10. The capacitor system of claim 9, further comprising a housing enclosing the plurality of capacitor stacks and the control circuit.

11. A device for energy storage and delivery, comprising:
a housing;
a plurality of capacitor stacks within the housing, each capacitor stack comprising:
an outer capacitor, and
an inner capacitor embedded within the outer capacitor;
a power supply connected to the outer capacitors; and
a microcontroller configured to control charging and discharging cycles of the outer and inner capacitors.

12. The device of claim 11, wherein the outer capacitor of each capacitor stack comprises a pair of conductive plates separated by a dielectric material.

13. The device of claim 12, wherein the conductive plates of the outer capacitor are made of a material selected from the group consisting of aluminum, copper, and stainless steel.

14. The device of claim 11, wherein the inner capacitor of each capacitor stack comprises a pair of conductive plates coated with activated carbon or graphene.

15. The device of claim 14, further comprising an electrolyte membrane positioned between the conductive plates of the inner capacitor.

16. The device of claim 11, wherein the microcontroller is programmed to maintain the voltage of each inner capacitor within a specified range.

17. The device of claim 16, wherein the microcontroller is further programmed to count a number of charging and discharging cycles and provide a warning signal when the number of cycles reaches a predetermined threshold.

18. The device of claim 11, wherein the plurality of capacitor stacks are arranged in a series configuration, a parallel configuration, or a combination thereof.

19. The device of claim 18, further comprising a display panel integrated into the housing for providing visual information about the device's operation.

20. The device of claim 19, wherein the microcontroller is configured to control the display panel to show at least one of: voltage levels, charging status, number of completed cycles, and warning signals.
